(19) United States
(12) Patent Application Publication
(10) Pub. No.: US 2026/0353045 A1
(43) Pub. Date: Nov. 5, 2026

(54) METHODS, ARCHITECTURES, APPARATUSES AND SYSTEMS FOR COMMUNICATION AIDED BY SENSING RESULTS

(71) Applicant: InterDigital Patent Holdings, Inc., Wilmington, DE (US)

(72) Inventors: Fumihiro Hasegawa, Westmount (CA); Remun Koirala, London (GB); Jonghyun Park, Syosset, NY (US); Afshin Haghighat, Ile-Bizard (CA); Jongwoo Hong, New York, NY (US); Paul Marinier, Brossard (CA)

(21) Appl. No.: 19/199,216

(22) Filed: May 5, 2025

(51) Int. Cl. H04W 4/38; H04L 5/00; H04W 24/08; H04W 72/1268

(52) U.S. Cl. CPC H04W 4/38; H04L 5/0048; H04W 24/08; H04W 72/1268

(57) ABSTRACT

Methods and systems are provided for aiding communications using a wireless transmit and/or receive unit (WTRU). In some implementations, the WTRU may receive, from a wireless network, sensing configuration information and configuration information indicating uplink (UL) resources. The WTRU may activate a time window based on an indication received from the wireless network that a target is expected, and based on the configuration information, perform one or more measurements of a reference signal (RS). The WTRU may, based on determining that a UL resource of the UL resources is scheduled within the activated time window and based on the one or more measurements of the RS satisfying a condition, transmitting, to the wireless network, a sounding reference signal (SRS) in the UL resource.

### TECHNICAL FIELD

The present disclosure is generally directed to the fields of communications, software and coding, including, for example, to methods, architectures, apparatuses, systems related to communications and sensing.

A device (e.g., a user equipment or a wireless transmit and/or receive unit) that is communicatively coupled to a wireless network may perform communications aided by sensing-related measurements (e.g., sensing results). Obstacles, for example, can block signals, reducing strength of the signals. The wireless network can detect and predict blockage. If, for example, a device in a vehicle moves slowly (e.g., due to a traffic jam), blockage can last a relatively long time. The wireless network may need more information about a target object as the vehicle (and thus the device) moves. Conventional methods lead to inaccurate results.

### BACKGROUND

User Equipment (UE) positioning in Next Generation Radio Access Network (NG-RAN) has been provided. For example, positioning methods, architectures, protocols, and procedures have been provided. Positioning methods such as Global Navigation Satellite System (GNSS), Observed Time Difference of Arrival (OTDOA), Enhanced Cell ID (E-CID), Wireless Local Area Network (WLAN), Bluetooth, Terrestrial Beacon System (TBS), sensor-based methods, New Radio Enhanced Cell ID (NR E-CID), Multi-Round Trip Time (Multi-RTT), Downlink Angle-of-Departure (DL-AoD), Downlink Time Difference of Arrival (DL-TDOA), Uplink Time Difference of Arrival (UL-TDOA), Uplink Angle-of-Arrival (UL-AoA), and Sidelink (SL) positioning and ranging have been provided. NG-RAN UE Positioning architecture, functional entities, and operations have been provided. Network interfaces, UE-terminated protocols like Long-Term Evolution Positioning Protocol (LPP), Radio Resource Control (RRC), Medium Access Control (MAC), Sidelink Positioning Protocol (SLPP), and NG-RAN node terminated protocols such as New Radio Positioning Protocol A (NRPPa) and NG Application Protocol (NGAP) have been provided. Procedures for capability transfer, assistance data transfer, location information transfer, error handling, and abort procedures have been provided. While UE positioning within the NG-RAN framework has been generally understood and implemented, communications were not aided by sensing results.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include receiving, from a wireless network, sensing configuration information, receiving, from the wireless network, configuration information indicating uplink (UL) resources, activating a time window based on an indication received from the wireless network that a target is expected, based on the configuration information, performing one or more measurements of a reference signal (RS), and based on determining that a UL resource of the UL resources is scheduled within the activated time window and based on the one or more measurements of the RS satisfying a condition, transmitting, to the wireless network, a sounding reference signal (SRS) in the UL resource. Other embodiments of this aspect include corresponding computer systems, apparatus, and computer programs recorded on one or more computer storage devices, each configured to perform the actions of the methods.

Implementations may include one or more of the following features: a method may include: based on the one or more measurements of the RS not satisfying the condition, transmitting, to the wireless network, a transmission in the UL resource where the transmission comprises at least one of a physical uplink shared channel (PUSCH) transmission or a physical uplink control channel (PUCCH) transmission. A method where the configuration information further indicates, a first indication of a first transmission configuration indicator (TCI)-state for downlink (DL) receptions and/or UL transmissions, and a second indication of a second TCI-state for the DL receptions and/or the UL transmissions. A method where the at least one of the PUSCH transmission or the PUCCH transmission is based on receipt of an explicit indication from the wireless network, or receipt of a time-domain offset parameter from the wireless network. A method further comprises switching the first TCI-state for the DL receptions and/or the UL transmissions to the second TCI-state for the DL receptions and/or UL transmissions at a configured time. A method where the condition comprises a reference signal received power (RSRP) being below a configured threshold. A method comprising determining that the one or more measurements of the RS satisfy the condition before the activated time window, and based on the sensing configuration information, performing one or more sensing measurements within the activated time window, and determining that the one or more measurements of the RS satisfy the condition within the activated time window. A method may include, based on determining that another UL resource of the UL resources is scheduled outside the activated time window, transmitting, to the wireless network, at least one of a physical uplink shared channel (PUSCH) transmission or a physical uplink control channel (PUCCH) transmission in the another UL resource. A method may include, based on the sensing configuration information, performing one or more measurements of the RS after the activated time window and before another activated time window, and transmitting, to the wireless network, a report indicating the one or more measurements of the RS before activating the another activated time window. Implementations of the described techniques may include hardware, a method or process, or a computer tangible medium.

In certain representative embodiments, a wireless transmit and/or receive unit (WTRU) is configured with first and second behavior. The WTRU is configured with entry and exit conditions. The WTRU is configured to perform first behavior (e.g., measurement, UL transmission). The WTRU determines to activate the second behavior and deactivate the first behavior if the entry condition is satisfied. The WTRU determines to deactivate the second behavior and activate the first behavior based on the exit condition.

In one general aspect, a WTRU may include a processor, and a transceiver coupled to the processor, where the WTRU is configured to: receive, from a wireless network, sensing configuration information, receive, from the wireless network, configuration information indicating uplink (UL) resources, activate a time window based on an indication received from the wireless network that a target is expected, based on the configuration information, perform one or more measurements of a reference signal (RS), and based on determining that a UL resource of the UL resources is scheduled within the activated time window and based on the one or more measurements of the RS satisfy a condition, transmitting, to the wireless network, a sounding reference signal (SRS) in the UL resource. Other embodiments of this aspect include corresponding computer systems, apparatus, and computer programs recorded on one or more computer storage devices, each configured to perform the actions of the methods.

Implementations may include one or more of the following features. A WTRU where the one or more processor is further configured to, based on the one or more measurements of the RS not satisfying the condition, transmitting, to the wireless network, a transmission in the UL resource, where the transmission comprises at least one of a physical uplink shared channel (PUSCH) transmission or a physical uplink control channel (PUCCH) transmission. A WTRU where the configuration information further indicates, a first indication of a first transmission configuration indicator (TCI)-state for downlink (DL) receptions and/or UL transmissions, and a second indication of a second TCI-state for the DL receptions and/or the UL transmissions. A WTRU where the at least one of the PUSCH transmission or the PUCCH transmission is based on receipt of an explicit indication from the wireless network, or receipt of a time-domain offset parameter from the wireless network. A WTRU where the one or more processor is further configured to switch the first TCI-state for the DL receptions and/or the UL transmissions to the second TCI-state for the DL receptions and/or UL transmissions at a configured time. A WTRU where the condition comprises a reference signal received power (RSRP) being below a configured threshold. A WTRU where the one or more processor is further configured to: determine that the one or more measurements of the RS satisfy the condition before the activated time window, and based on the sensing configuration information, perform one or more sensing measurements within the activated time window. A WTRU where the processor is further configured to determine that the one or more measurements of the RS satisfy the condition within the activated time window. A WTRU where the one or more processor is further configured to: based on determining that another UL resource of the UL resources is scheduled outside the activated time window, transmit, to the wireless network, at least one of a physical uplink shared channel (PUSCH) transmission or a physical uplink control channel (PUCCH) transmission in the another UL resource. A WTRU where the one or more processor is further configured to, based on the sensing configuration information, perform one or more measurements of the RS after the activated time window and before another activated time window, and transmit, to the wireless network, a report indicating the one or more measurements of the RS before activating the another activated time window. Implementations of the described techniques may include hardware, a method or process, or a computer tangible medium.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:
a) FIG. 1A is a system diagram illustrating an example communications system,
b) FIG. 1B is a system diagram illustrating an example wireless transmit and/or receive unit (WTRU) that may be used within the communications system illustrated in FIG. 1A,
c) FIG. 1C is a system diagram illustrating an example radio access network (RAN) and an example core network (CN) that may be used within the communications system illustrated in FIG. 1A,
d) FIG. 1D is a system diagram illustrating a further example RAN and a further example CN that may be used within the communications system illustrated in FIG. 1A,

FIG. 2 is an example data structure of a Downlink Control Information (DCI) field of a DCI for unified transmission configuration indicator (TCI)-state indications, in accordance with one or more embodiments of the present disclosure,

FIG. 3A is an example of a system including down-link reference signals (DL-RSs) when an obstacle is not blocking a beam between a WTRU and two transmission reception points (TRPs), in accordance with one or more embodiments of the present disclosure,

FIG. 3B is an example of the system including the DL-RSs when the obstacle is blocking a beam between the WTRU and at least one of the two transmission reception points (TRPs), in accordance with one or more embodiments of the present disclosure,

FIG. 4A is an example a system including DL-RSs when an obstacle is not blocking a beam between a WTRU and a TRP, in accordance with one or more embodiments of the present disclosure,

FIG. 4B is an example of the system including the DL-RSs when the obstacle is blocking a beam between the WTRU and the TRP, in accordance with one or more embodiments of the present disclosure,

FIG. 5 is an example of a sequence diagram of communications aided by sensing results between a gNode-B (gNB) and a WTRU, in accordance with one or more embodiments of the present disclosure,

FIG. 6 is an example of a chart representing a Channel Impulse Response (CIR) estimate, in accordance with one or more embodiments of the present disclosure,

FIG. 7 is an example of system having a spatial relationship between a DL signal and an up-link reference signal (UL-RS), in accordance with one or more embodiments of the present disclosure,

FIG. 8 is an example of a chart representing a multipath delay profile, in accordance with one or more embodiments of the present disclosure,

FIG. 9A is an example of WTRU report content indicating spatial and delay relationships with respect to DL-RS #1, in accordance with one or more embodiments of the present disclosure,

FIG. 9B is an example of WTRU report content indicating spatial, power, and delay relationships with respect to DL-RS #1, in accordance with one or more embodiments of the present disclosure,

FIG. 10 is an example of a chart representing associating UL-RS information to sample-based measurements, in accordance with one or more embodiments of the present disclosure,

FIG. 11A is an example of a system including a beam between a gNB and a WTRU at a first time before arrival of an obstacle or target, in accordance with one or more embodiments of the present disclosure,

FIG. 11B is an example of the system including a time scheduled beam switch at a second time after the first time, in accordance with one or more embodiments of the present disclosure,

FIG. 11C is an example of the system including a switched beam between the gNB and the WTRU at a third time at arrival of the obstacle or target, in accordance with one or more embodiments of the present disclosure,

FIG. 12A is an example of a system including a “do not measure” flag for a first beam between a gNB and a WTRU at a first time period before arrival of an obstacle or target, in accordance with one or more embodiments of the present disclosure,

FIG. 12B is an example of the system including a “do not measure” flag for a second beam between the gNB and the WTRU at a second time period at arrival of the obstacle or target, in accordance with one or more embodiments of the present disclosure,

FIG. 12C is an example of the system including a “do not measure” flag for a third beam between the gNB and the WTRU at a third time period after departure of the obstacle or target, in accordance with one or more embodiments of the present disclosure,

FIG. 12D is an example of a chart of the “do not measure” flags for the first, second, and third beams, at the first, second, and third time periods, in accordance with one or more embodiments of the present disclosure,

FIG. 13A is an example of a system including periodic transmit and/or receive of an SRS between a gNB and a WTRU at a first time period before arrival of an obstacle or target, in accordance with one or more embodiments of the present disclosure,

FIG. 13B is an example of the system including a “do not transmit” period for the SRS between the gNB and the WTRU at a second time period at arrival of the obstacle or target, in accordance with one or more embodiments of the present disclosure,

FIG. 13C is an example of the system including periodic transmit and/or receive of another SRS between the gNB and the WTRU at a third time period after departure of the obstacle or target, in accordance with one or more embodiments of the present disclosure,

FIG. 13D is an example of a chart of the periodic transmit and/or receive of the SRSs before and after the “do not transmit” flag at the first, second, and third time periods, in accordance with one or more embodiments of the present disclosure,

FIG. 14A is an example of a sequence diagram of activation of a frequency resource between a gNB and a WTRU, in accordance with one or more embodiments of the present disclosure,

FIG. 14B is an example of a chart of a first frequency resource at a first time, in accordance with one or more embodiments of the present disclosure,

FIG. 14C is an example of a chart of a second frequency resource at a second time, in accordance with one or more embodiments of the present disclosure,

FIG. 15A is an example of a system including transmit and/or receive of a DL-RS for RSRP measurement between a gNB and a WTRU at a first time period before arrival of an obstacle or target, in accordance with one or more embodiments of the present disclosure,

FIG. 15B is an example of the system including a multipath measurement for the DL-RS for the RSRP measurement between the gNB and the WTRU at a second time period at arrival of the obstacle or target, in accordance with one or more embodiments of the present disclosure,

FIG. 15C is an example of the system including transmit and/or receive of another DL-RS for another RSRP measurement between the gNB and the WTRU at a third time period after departure of the obstacle or target, in accordance with one or more embodiments of the present disclosure,

FIG. 15D is an example of a chart of the transmitted and/or received DL-RS and the multipath measurement for the RSRP measurement at the first, second, and third time periods, in accordance with one or more embodiments of the present disclosure,

FIG. 16A is an example of a system including transmit and/or receive of a first DL-RS between a gNB and a WTRU for a first measurement at a first time period, in accordance with one or more embodiments of the present disclosure,

FIG. 16B is an example of the system including transmit and/or receive of a second DL-RS between the gNB and the WTRU for a second measurement at a second time period, in accordance with one or more embodiments of the present disclosure,

FIG. 16C is an example of the system including transmit and/or receive of another first DL-RS between the gNB and the WTRU for a third measurement at a third time period, in accordance with one or more embodiments of the present disclosure,

FIG. 16D is an example of a chart of the transmitted and/or received DL-RS and the measurements at the first, second, and third time periods, in accordance with one or more embodiments of the present disclosure,

FIG. 17 is an example of a system including a low RSRP in a received DL-RS at a primary TRP due to a presence of a target, in accordance with one or more embodiments of the present disclosure,

FIG. 18 is an example of a sequence diagram of signal exchange between a WTRU and a network (NW), in accordance with one or more embodiments of the present disclosure,

FIG. 19 is an example of a chart of skipping reporting of sensing results outside of an active time (e.g., between first and second active time periods), in accordance with one or more embodiments of the present disclosure,

FIG. 20 is an example of a sequence diagram of aperiodic channel state information (CSI) reporting in case of a disruption of reception of a CSI-RS between a gNB and a WTRU, in accordance with one or more embodiments of the present disclosure,

FIG. 21 is an example of CSI report configurations for first and second conditions and for four triggers states, in accordance with one or more embodiments of the present disclosure,

FIG. 22 is an example of a sequence diagram of signals between a WTRU and a NW, in accordance with one or more embodiments of the present disclosure, and

FIG. 23 is an example process for communications aided by sensing-related measurements, in accordance with one or more embodiments of the present disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### a) Example Communications System

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

a) FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit and/or receive units (WTRUs) 102a, 102b, 102c, 102d, a RAN 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

a) FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor, a geolocation sensor, an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

a) FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

a) FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANS (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

It will be understood that a wireless network may include any suitable components and devices, including, for example, any of one or more base stations, one or more transmission reception points (TRPs), one or more gNBs, one or more WTRUs, any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

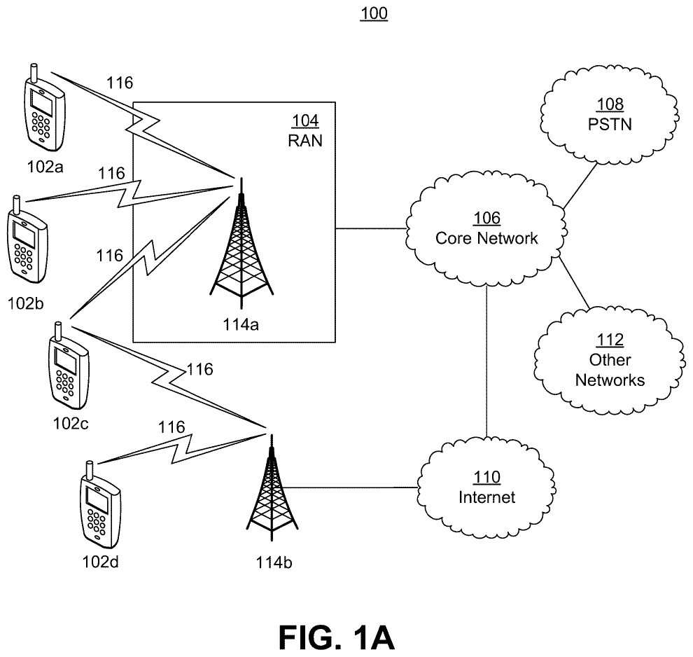

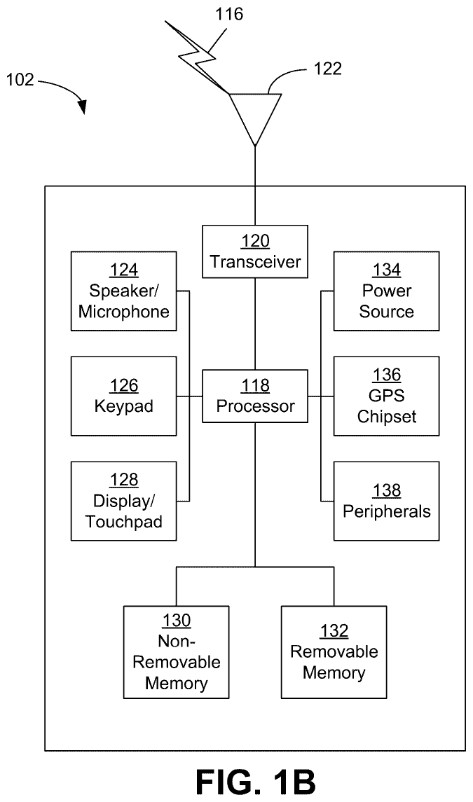

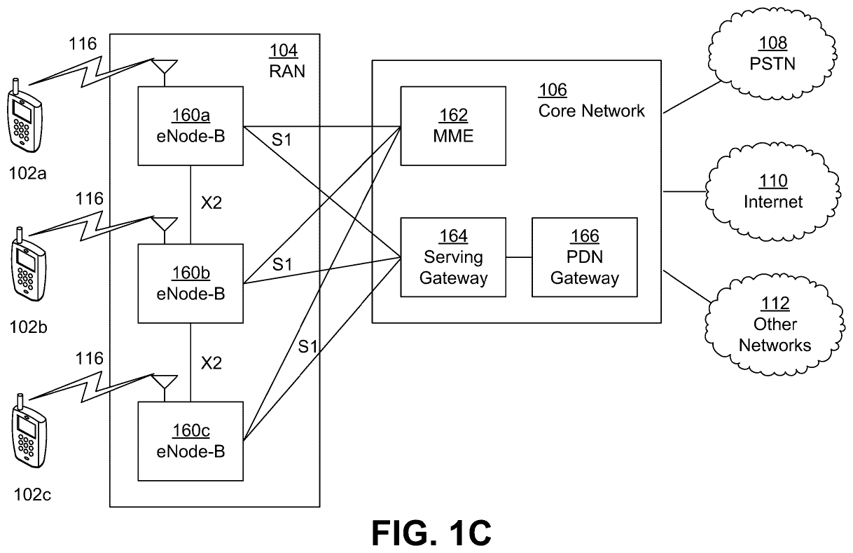

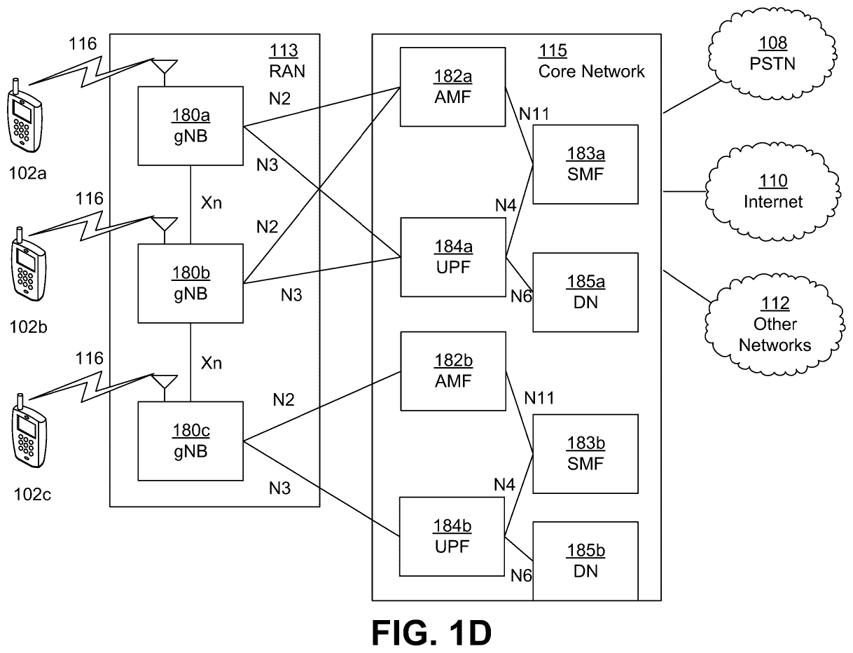

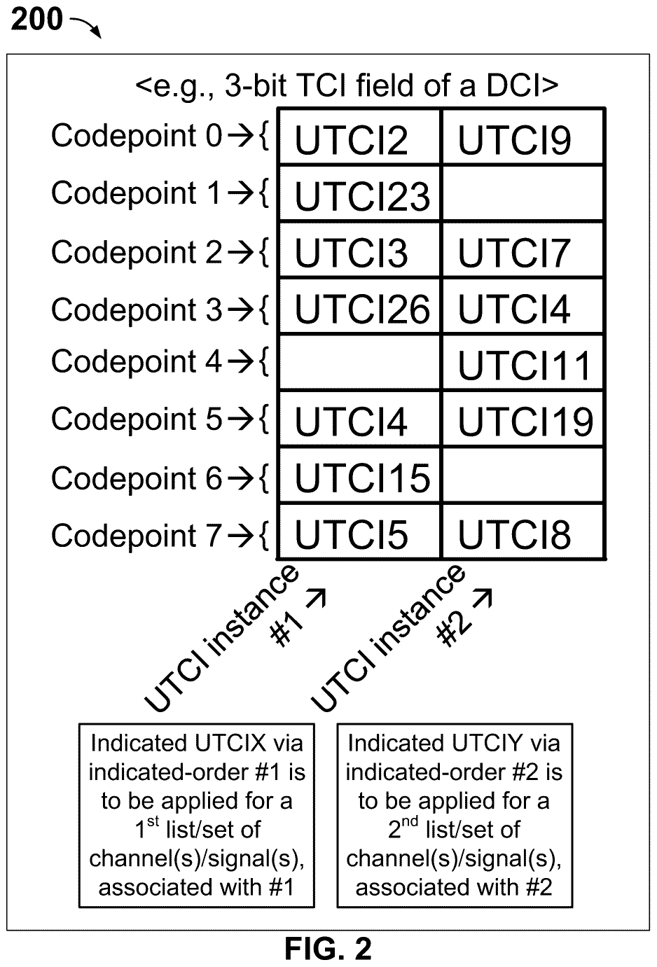

In certain embodiments of the present disclosure, the devices, systems, architectures, communication links, apparatuses, and other elements depicted in FIGS. 1A-1D may be used in connection with at least one of communications, measurement, sensing, or reporting of the same including embodiments described below at least in connection with FIGS. 2-23.

In certain representative embodiments, a WTRU (e.g., 102, 390, 490, 590, 704, 1190, 1290, 1390, 1490, 1590, 1690, 1790, 1890, 2090, 2290) is configured with first and second behavior. The WTRU is configured with entry and exit conditions. The WTRU is configured to perform first behavior (e.g., measurement, UL transmission). The WTRU determines to activate the second behavior and deactivate the first behavior if the entry condition is satisfied. The WTRU determines to deactivate the second behavior and activate the first behavior based on the exit condition.

An obstacle may block a line-of-sight (LOS) of DL-RSs, degrading RSRP for the blocked DL-RSs (e.g., blocked DL-RSs). The NW may detect obstacles, and the NW may predict DL-RSs that may be blocked.

For example, a WTRU is configured for communications aided by sensing. The WTRU may send a request to the wireless network for a configuration (e.g., down-link reference signal (DL-RS) configurations, up-link reference signal (UL-RS) configurations) in Physical Uplink Shared Channel (PUSCH), Physical Uplink Control Channel (PUCCH), Uplink Control Information (UCI), medium access control-control element (MAC-CE), radio resource control (RRC) or LTE positioning protocol (LPP) message. The request from the WTRU may include configurations of, for example, a measurement gap, DL-RS processing window, or window for transmission of UL-RSs.

The WTRU may send an acknowledgment message (e.g., in PUSCH or PUCCH) for the grant message received from the wireless network. The WTRU may be configured with more than one condition and associated WTRU behavior. The WTRU may determine which WTRU behavior the WTRU uses based on an applicable condition. In some embodiments, more than one condition or criterion can be used in combination thereof.

The WTRU may measure DL inside or outside of an active bandwidth part (BWP). In some embodiments, the WTRU may transmit UL-RS inside or outside of the active BWP. The WTRU may be preconfigured with parameters (e.g., measurement gaps, DL-RS processing windows, DL-RS configurations, or UL-RS configurations) via a semi-static message (e.g., LPP or RRC). In some embodiments, any actions the WTRU determines to take may be configured by the wireless network. For example, the WTRU may be configured with a rule, in accordance with the WTRU may determine to take an associated action. In addition to the measurements made on DL-RS, the WTRU may include at least one of the following cell-related measurements: (1) synchronization signal burst (SSB) reference signal received power (RSRP) from the serving cell with corresponding cell ID, (2) SSB RSRP from one or more neighboring cells with corresponding cell IDs, (3) RSRP of channel state information-reference signal (CSI-RS) with CSI-RS resource ID, or (4) RSRP of demodulation-reference signal (DM-RS).

### TERMINOLOGY

Hereinafter, the term “network” may correspond to a function, node and/or a protocol that terminates in the radio access (e.g., gNB, next-generation RAN (NG-RAN)) entity or in the core network (e.g., access mobility management function (AMF), location management function (LMF)) data collection function or any other suitable function. The terms “pre-configuration” and “configuration” may be used interchangeably. The terms “non-serving gNB” and “neighboring gNB” may be used interchangeably. The terms “gNB” and “transmission reception point (TRP)” may be used interchangeably. The terms “DL-RS” or “DL-RS resource” may be used interchangeably. The terms “DL-RS(s)” or “DL-RS resource(s)” may be used interchangeably. In some embodiments, the aforementioned “DL-RS(s)” or “DL-RS resource(s)” may belong to different DL-RS resource sets. The terms “measurement gap” or “measurement gap pattern” may be used interchangeably. A “measurement gap pattern” may include parameters such as measurement gap duration, measurement gap repetition period, or measurement gap periodicity.

An LMF may be a non-limiting example of a node or entity (e.g., network node or entity) that may be used for or to support positioning or sensing. In some embodiments, any other node or entity may be substituted for the LMF in accordance with the present disclosure. In some embodiments, the WTRU may receive one or more preconfigured thresholds from the wireless network (e.g., LMF, gNB).

The WTRU may receive an indication, request, and/or configurations from the network in dynamic (e.g., DCI, MAC-CE) or semi-static message (e.g., RRC, LPP, NAS). The WTRU may respond to the request from the network via dynamic (e.g., UCI, MAC-CE) or semi-static message (e.g., RRC, LPP, NAS).

In some implementations, a line-of-sight (LOS) indicator may be a hard indicator (e.g., 1 or 0) or a soft indicator (e.g., 0, 0.1, 0.2 . . . , 1). The LOS indicator may indicate a likelihood of the presence of an LOS path (a) between a TRP and the WTRU or (b) along a DL-RS. The LOS indicator may be associated with a TRP or positioning reference signal (PRS) resource ID (e.g., an index). In some embodiments, the WTRU may receive a LOS indicator from the network for each TRP or PRS resource ID. In alternative implementations, the WTRU may determine the LOS indicator for each TRP or PRS resource ID based on measurements performed by the WTRU. In the examples described herein, “ID” and “index” may be used interchangeably.

A WTRU location may be expressed in terms of altitude, latitude, geographic coordinate, local coordinate, or using any other suitable way to indicate position or location. In the examples described herein, a timestamp may be indicated by an absolute time, relative time (e.g., in seconds) compared to a reference time, system frame number (SFN), slot index, frame index, subframe index and/or symbol index. Examples of “absolute time” may be universal time coordinated (UTC) time, global navigation satellite system (GNSS) time, or locally defined absolute time (e.g., LTE or NR Time).

In the examples described herein, the WTRU may receive configurations for a time window, which may include at least one of: (a) a duration (e.g., expressed in terms of seconds, number of symbols, number of slots, number of frames, or number of subframes), or (b) a start and/or end time (e.g., expressed in terms of absolute time, system time, relative time with respect to a reference time indicated by the wireless network or determined by the WTRU, SFN index, slot index, symbol index, frame index, or subframe index). The WTRU may receive more than one configuration of a time window where each configuration is associated with an index. The time window may be initiated by receiving a trigger signal sent from the wireless network. For example, the WTRU may receive a command (e.g., downlink control information (DCI)) to initiate a time window associated with a corresponding configuration index. The WTRU may determine to initiate the time window after a (e.g., configured) period of time (e.g., N symbols, N slots, N frames, N seconds) after receiving the command (e.g., the DCI). In some embodiments, the WTRU may receive, from the wireless network, an activation command or deactivation command (e.g., DCI, MAC-CE) to activate or deactivate the time window, respectively.

One or more configurations for RSs are provided. In some embodiments, the WTRU may receive, from the wireless network (e.g., the LMF), sounding reference signal (SRS) configurations (e.g., DL-RS and/or UL-RS configurations) to determine the position of the WTRU. The LMF may forward a PRS configuration and the SRS configurations to the gNB such that the gNB schedules PRS transmission or SRS reception at one or more of the TRP, transmission point (TP), and reception point (RP).

In some embodiments, a DL-RS configuration may include at least one of the following parameters: (1) a number of symbols, (2) transmission power, (3) a number of DL-RS resources included in a DL-RS resource set, (4) a muting pattern for DL-RS (e.g., a bitmap indicative of the muting pattern), (5) a periodicity, (6) a type of DL-RS (e.g., periodic DL-RS, semi-persistent DL-RS, or aperiodic DL-RS), (7) a slot offset for periodic transmission for DL-RS, (8) a vertical shift of DL-RS pattern in the frequency domain, (9) a time gap during repetition, (10) a repetition factor, (11) a resource element (RE) offset, (12) comb pattern, (13) comb size, (14) a spatial relation (e.g., with respect to other DL-RSs or UL-RS such as SRS for positioning purposes), (15) quasi co-location (QCL) information (e.g., QCL target, QCL source) for DL-RS, (16) a number of TRPs, (17) an Absolute Radio-Frequency Channel Number (ARFCN), (18) subcarrier spacing, (19) an expected reference signal time difference (RSTD), (20) an uncertainty in expected RSTD, (21) a start Physical Resource Block (PRB), (22) bandwidth, (23) BWP ID, (24) a number of frequency layers, (25) a start and/or end time for DL-RS transmission, (26) an on and/or off indicator for DL-RS, (27) a TRP ID, (28) a DL-RS ID, (29) a cell ID, (30) a global cell ID, and/or (31) an applicable time window. In some embodiments, the WTRU may apply a DL-RS configuration within the applicable time window. As described herein, the term “ID” may be used interchangeably with “index”. Some examples of a DL-RS are channel state information reference signal (CSI-RS), phase tracking reference signal (PTRS), PRS, tracking reference signal (TRS), and SSB.

One or more configurations for CSI-RS are provided. In one example, the CSI-RS resource set configurations (e.g., NZP-CSI-RS-ResourceSet) may include at least one of: resource ID, periodicity and slot offset, resource mapping to define the number of CSI-RS ports, CDM-type, and OFDM symbol and subcarrier occupancy of the CSI-RS resource within a slot, bandwidth part ID, scrambling ID, power control configurations including power control offset, (e.g., a QCL relationship between CSI-RS and other reference signals), QCL type (e.g., QCL type A, QCL type B, QCL type D), resource set ID, list of CSI-RS resources in the resource set, list of CSI-RS resource sets. “ID” may be used interchangeably with “index”.

In some embodiments, the UL-RS configuration or SRS configuration may include at least one of: (1) a resource ID, (2) comb offset values or cyclic shift values, (3) a start position in the frequency domain, (4) a number of UL-RS symbols, (5) a shift in the frequency domain for UL-RS, (6) a frequency hopping pattern, (7) a type of UL-RS (e.g., aperiodic UL-RS, semi-persistent UL-RS, or periodic UL-RS), (8) a sequence ID used to generate UL-RS, or other IDs used to generate a UL-RS sequence, (9) spatial relation information, indicating which reference signal (e.g., DL-RS, UL-RS, CSI-RS, SRS, DM-RS) or an SSB (e.g., SSB ID or cell ID of the SSB) to which the UL-RS is spatially related, where the UL-RS and DL-RS may be aligned spatially, (10) QCL information (e.g., a QCL relationship between UL-RS and other reference signals or SSB), (11) a QCL type (e.g., QCL type A, QCL type B, QCL type C, or QCL type D), (12) a resource set ID, (13) a list of UL-RS resources in the resource set, (14) transmission power related information, (15) pathloss reference information which may contain an index for an SSB, CSI-RS or DL-RS, (16) a periodicity of UL-RS transmission, and/or (17) spatial information such as spatial direction information of UL-RS transmission (e.g., beam information or angles of transmission), spatial direction information of DL-RS reception (e.g., a beam ID used to receive the DL-RS, or angle of arrival (AoA)). Some examples of UL-RS include SRS and SRS for positioning purposes.

In 3GPP, the following categories of WTRU positioning techniques are specified: (a) DL positioning method, (b) UL positioning method, and (c) DL & UL positioning method. A “DL positioning method” may refer to any positioning method that uses DL-RSs such as PRSs. In some embodiments, the WTRU receives multiple RSs from one or more TPs and measures DL-RSTD and/or RSRP. Some examples of DL positioning methods are DL angle of departure (DL-AoD) or DL time difference of arrival (DL-TDOA) positioning. A “UL positioning method” may refer to any positioning method that uses UL-RSs such as SRS for positioning. In some embodiments, the WTRU transmits SRS to multiple RPs and the RPs measure the UL relative time of arrival (RTOA) and/or RSRP. Some examples of UL positioning methods are UL-TDOA or UL-AoA positioning. A “DL & UL positioning method” may refer to any positioning method that uses ULRSs and DL-RSs for positioning purposes. In one example, a WTRU transmits SRS to multiple TRPs and a gNB measures a receive-to-transmit (Rx-Tx) time difference, which is calculated based on a time of arrival of a DL-RS (e.g., PRS). In some embodiments, the gNB may measure RSRP for the received SRS. In some embodiments, the WTRU measures the Rx-Tx time difference for a PRS transmitted from multiple TRPs. In addition, the WTRU may measure RSRP for the received PRS. The Rx-Tx difference and RSRP measured at the WTRU and the gNB may be used to calculate a round-trip time (RTT). The term “WTRU Rx-Tx time difference” may refer to the difference between the arrival time of the RS transmitted by the TRP and the transmission time of the RS transmitted from the WTRU. One example of a DL & UL positioning method is multi-RTT positioning.

In one example, the WTRU may obtain a Channel Impulse Response (CIR) from the wireless network. The wireless network may indicate, to the WTRU, one or more DL-RS configurations such as DL-RS resource IDs associated with the CIR. For example, the CIR may be associated with a DL-RS resource ID. In such an example, the WTRU may determine that the CIR is based on the measurements made using the DL-RS resource associated with the ID. Alternatively, the WTRU may determine that the channel along the direction of (a) transmission of the DL-RS or (b) reception of the DL-RS, corresponds to the CIR.

In another example, the CIR may be associated with a TRP ID. In some embodiments, the WTRU may determine that the CIR represents the channel between an associated TRP and WTRU. In further examples, the CIR may be associated with more than one TRP, where the wireless network may include TRP indices associated with the CIR.

In some embodiments, the CIR may be associated with a cell. In such embodiments, the WTRU may receive a cell ID or index associated with the CIR from the wireless network. In other embodiments, the CIR may be associated with more than one TRP or DL-RS resource ID. In such embodiments, the WTRU may determine that the channel between the TRPs and the WTRU corresponds to the CIR. Alternatively, the WTRU may determine that the channel along the transmission directions of DL-RSs associated with IDs or reception directions of the DL-RS correspond to the CIR.

In another example, more than one CIR may be associated with one parameter from DL-RS configurations (e.g., a TRP ID, a DL-RS resource ID, or a frequency layer ID). For example, the WTRU may receive, from the wireless network, information related to two CIRs associated with a TRP. Alternatively, the WTRU may report, to the wireless network, information related to more than one CIR associated with a parameter of the DL-RS configuration (e.g., a TRP ID or a DL-RS resource ID) based on measurements. There may be more than one CIR associated with a DL-RS configuration since the WTRU or wireless network may observe different channel characteristics based on the AoA of the DL-RS or the UL-RS, for example.

A CIR may be represented by a channel delay profile such as delay profile (DP) or a power delay profile (PDP). A PDP may be defined as a set of delays and power profiles, such as [τ₀, τ₁, . . . , τ_{N-1}] and [p₀, p₁, . . . , p_{N-1}], where pₖ may corresponds to relative power at the kth path compared to the first path. A delay profile may be defined as a set of delays [τ₀, τ₁, . . . , τ_{N-1}], with respect to a reference timing (e.g., first path, indicated reference timing), which may indicate a path delay for each path. Each path may have a path power above p_{threshold}. The WTRU may receive p_{threshold} from the wireless network to determine the delay profile based on the power delay profile.

In another example, the CIR the WTRU reports to the wireless network may be defined by a (e.g., configured) number of samples (e.g., N number of samples) where the WTRU is configured with a granularity of samples (e.g., X seconds apart). The WTRU may report samples corresponding to RSRPs over a configured RSRP threshold or samples corresponding to an M highest RSRPs among the samples. The WTRU may indicate locations or sample indices of samples where the WTRU measures the M highest RSRP samples. The first sample may be defined as the earliest arriving path, e.g., the first path. The WTRU may report timing, phase, and/or power information per sample.

In one example, the WTRU may receive an indication from the wireless network on how to generate CIR, PDP, or DP based on timing, phase, and/or power measurements. In some embodiments, the WTRU may send a request to the wireless network to then receive, from the wireless network, an indication of which methodologies to use to generate CIR, PDP, or DP based on the measurements performed by the WTRU. For example, the WTRU may receive a message from the wireless network (e.g., via LPP, RRC, MAC-CE, or DCI), the message indicating the DL-RS resource indices and associated measurement types (e.g., RSTD, AoA) to use to generate CIRs, PDPs or DPs. In some embodiments, the WTRU may receive, from the wireless network, an indication indicating the DL-RS resource indices and associated measurement types (e.g., RSTD, AoA) to generate CIRs, PDPs, or DPs.

In some embodiments, the WTRU may receive at least one of (1) a threshold (e.g., a power threshold), (2) a timing range (e.g., 0 μs to 1 μs), or (3) timing granularity (e.g., every 0.1 us in the indicated timing range, or 100 sample points in the indicated timing range), e.g., of at least one of (a) CIRs, (b) PDPs and/or (c) DPs. In such embodiments, the WTRU may determine to report power and timing (e.g., relative timing compared to a reference timing, or absolute timing) of any samples whose corresponding received power is greater than the threshold (e.g., p_{threshold}).

The WTRU may send measurements in a report to the wireless network (e.g., LMF or gNB) via a semi-static message (e.g., LPP or RRC) or a dynamic message (e.g., UCI or UL MAC CE). In the examples discussed herein, DL-RS (e.g., CSI-RS, DM-RS, and TRS) and SSB may be used interchangeably.

In examples provided herein, measurements and/or reporting of measurements may refer to actual measurements and/or other suitable, associated, quantities. Such quantities may include post-processed measurements and/or a determined characterization thereof (e.g., a timing, signal processing window, number of samples, or any other suitable characterization).

In certain representative embodiments, one or more TCI states are provided. A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving an RS (such as CSI-RS) or a SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by RRC or signaled by MAC CE or DCI. For example, a WTRU may implicitly transmit PUSCH and DM-RS of PUSCH according to the same spatial domain filter as an SRS indicated by an SRS resource indicator (SRI) indicated in DCI or configured by RRC. In another example, a spatial relation may be configured by RRC for an SRI or signaled by MAC CE for a PUCCH. Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a transmission configuration indicator (TCI) state. A WTRU may be indicated an association between a CSI-RS or SS block and a DM-RS by an index to a set of TCI states configured by RRC and/or signaled by MAC CE. Such indication may also be referred to as a “beam indication”.

For example, quasi co-location (QCL) assumptions and configurations are provided. A WTRU may receive transmit configuration indication (TCI) related configuration(s), e.g., comprising a plurality of TCI-states (e.g., an RRC-configured pool of TCI-states (e.g., as unified TCI framework), ‘TCI-State’ IE, ‘TCI-UL-State’ IE, ‘spatialRelationInfo’ IE, etc.). A TCI-state of the plurality of TCI-states may be associated (comprised) with at least one of QCL-info #1, QCL-info #2, additionalPCI, pathloss RS (PLRS)-ID, UL-PC, Timing Advance Group (TAG)-ID, where QCL-info #1 (or QCL-info #2) may comprise a cell-ID (e.g., serving-cell index), a BWP-ID, a RS (e.g., CSI-RS, SSB-index), and/or a QCL-type which may be one of typeA, typeB, typeC, typeD. In an example, the PLRS-ID may be for pathloss estimation for determining a UL transmission power when a UL transmission is based on a TCI-state that is associated with the PLRS-ID. In an example, the UL-PC (e.g., UL-PC parameter set, which may comprise at least one of P0, alpha, close-loop (CL)-index, power offset, etc.) may be for determining an uplink power for an UL transmission associated with the TCI-state. In an example, the additionalPCI may be a physical cell-ID (PCID) of a neighboring (surrounding) cell that the RS (associated with the TCI-state), e.g., SSB-index (or CSI-RS) may be transmitted from, e.g., as an inter-cell beam (or RS) reference. In an example, the WTRU may apply a timing advance value (e.g., based on received timing advance command (TAC) (s)) in association with the TAG-ID (e.g., of multiple TAG-IDs being configured) to a scheduled UL transmission. For example, a type of an identifier includes at least one of typeA, which may represent {Doppler shift, Doppler spread, average delay, delay spread}, typeB, which may represent {Doppler shift, Doppler spread}, typeC, which may represent {Doppler shift, average delay}, and typed, which may represent {Spatial Rx parameter}.

When a WTRU receives an indication or configuration of a TCI-state (e.g., applicable for a physical channel or signal) at least comprising a QCL-type (e.g., by typeA, typeB, typeC, or typeD) and an RS (e.g., an RS associated with the QCL-type), the WTRU may determine (e.g., derive) at least one parameter for transmission and/or reception, representing wireless channel characteristics (e.g., at least one of Doppler shift, Doppler spread, average delay, delay spread, Spatial Rx parameter) based on the indicated QCL-type, and apply the at least one parameter for transmission or reception of the physical channel or signal.

For example, unified TCI (UTCI) is provided. A unified TCI (e.g., a common TCI, a common beam, a common RS, etc.) may refer to a beam and/or RS to be (simultaneously) used for multiple physical channels and/or signals. The term “TCI” may at least comprise a TCI state that includes at least one source RS to provide a reference (e.g., WTRU assumption) for determining QCL and/or spatial filter.

In an example, a WTRU may receive (e.g., from a gNB) an indication of a first unified TCI to be used and/or applied for both a downlink control channel (PDCCH) and a downlink shared channel (PDSCH) (e.g., and a downlink RS). The source reference signal(s) in the first unified TCI may provide common QCL information at least for WTRU-dedicated reception on the PDSCH and all (or subset of) CORESETs in a CC. In an example, a WTRU may receive (e.g., from a gNB) an indication of a second unified TCI to be used and/or applied for both an uplink control channel (PUCCH) and an uplink shared channel (PUSCH) (e.g., and an uplink RS). The source reference signal(s) in the second unified TCI may provide a reference for determining common UL TX spatial filter(s) at least for dynamic-grant and/or configured-grant based PUSCH, and all (or subset of) dedicated PUCCH resources in a CC.

The WTRU may be configured with a first mode for unified TCI (e.g., SeparateDLULTCI mode, a parameter of ‘unifiedTCI-StateType’ set to ‘separate’) where an indicated unified TCI (e.g., the first unified TCI or the second unified TCI) may be applicable for either downlink (e.g., based on the first unified TCI) or uplink (e.g., based on the second unified TCI).

In an example, a WTRU may receive (e.g., from a base station (BS), a gNB, a TRP, etc.) an indication of a second unified TCI to be used and/or applied commonly for a PDCCH, a PDSCH, a PUCCH, and a PUSCH (and a DL-RS and/or a UL-RS).

The WTRU may be configured with a second mode for unified TCI (e.g., JointTCI mode, a parameter of ‘unifiedTCI-StateType’ set to ‘joint’) where an indicated unified TCI (e.g., the third unified TCI) may be applicable for both downlink and uplink (e.g., based on the third unified TCI).

The WTRU may determine a TCI state applicable to a transmission or reception by first determining a Unified TCI state instance (e.g., TCI-state group, a group of TCI-states, a set of activated TCI-states) applicable to this transmission or reception, then determining a TCI state corresponding to the Unified TCI state instance. A transmission may consist of at least PUCCH, PUSCH, SRS. A reception may consist of at least PDCCH, PDSCH, CSI-RS. A Unified TCI state instance may also be referred to TCI state group, TCI state process, unified TCI pool, a group of TCI states, a set of time-domain instances and/or stamps and/or slots and/or symbols, and/or a set of frequency-domain instances and/or RBs and/or subbands, etc. A Unified TCI state instance may be equivalent or identified to a Coreset Pool identity (e.g., CORESETPoolIndex, a TRP indicator, and/or the like).

Hereafter, unified TCI may be interchangeably used with one or more of unified TCI-states, unified TCI instance, TCI, and TCI-state, but still consistent with this invention.

A WTRU may be configured with a plurality of transmission configuration indicator (TCI) states, e.g., unified TCI (UTCI) states, each applicable for multiple channel(s) and/or signal(s). The multiple channel(s) and/or signal(s) may be configured to the WTRU (or pre-determined or defined), e.g., in a form of a list, by a higher-layer signaling (e.g., RRC and/or MAC-CE) which may comprise at least one of the following (e.g., as a combination): one or more CORESETs, one or more PDCCH candidates, one or more search spaces, one or more PDSCHs (e.g., PDSCH occasions and/or configurations and/or instances, etc.), one or more RSs (e.g., CSI-RSs, DMRSs, SSB indexes, PRSs, PTRSs, and/or SRSs), one or more PUSCHs (e.g., PUSCH occasions and/or configurations and/or instances, etc.), one or more PUCCH resources (e.g., PUCCH resource sets and/or groups), or one or more PRACH occasions and/or resources and/or RSs.

The plurality of TCI states may be configured via an RRC signaling (e.g., and/or via a MAC-CE signaling, indication or activation). The WTRU may receive, e.g., via the MAC-CE or a separate signaling, an information content comprising mapping between one or more codepoints of a DCI field (e.g., TCI field, and/or TCI selection field) and at least one TCI state of the plurality of TCI states. The WTRU may receive a DCI comprising the DCI field. The WTRU may be indicated with one or more TCI states, of the plurality of TCI states, mapped to a codepoint of the one or more codepoints of the DCI field, where each of the one or more TCI states is applicable after a time duration determined based on a beam application time (BAT) parameter.

FIG. 2 shows an example data structure 200 of the DCI field (e.g., TCI field) of a DCI for unified TCI-state indications. The WTRU may receive the mapping between a codepoint (of the DCI field) and one or more TCI states, illustrated in FIG. 2, e.g., via a MAC-CE signaling. For example, Codepoint 2 is mapped to {UTCI3, UTCI7}, where the WTRU may apply at least one of {UTCI3, UTCI7} to the multiple channel(s) and/or signal(s), e.g., based on a list of the multiple channel(s) and/or signal(s) configurable by a higher layer signaling from a gNB. In an example, the list of the multiple channel(s) and/or signal(s) may be given per UTCI instance (e.g., TCI-state group, a group of TCI-states, a set of activated TCI-states, associated with a TRP, associated with CORESET(s)), where the UTCI instance may correspond to each column of the mapping table, illustrated in FIG. 2, between a codepoint and the one or more TCI states.

For example, WTRU capabilities are provided. In one example, the WTRU may determine to send a WTRU capability report to the network based on a request from the network or as a part of initial access procedure. The WTRU can be at least one of stationary or mobile, configured to measure various signals periodically, configured to process and report these measurements, configured to perform sensing and communication, configured to support multiple cells, configured to determine its location, or configured to use various hardware for sensing.

The WTRU capability may include at least one of the following: (1) Whether the WTRU is stationary or mobile device. An example of stationary device is a device that is plugged into an electric outlet. An example of a mobile device may be a handset, or a device that is attached to a mobile object such as a car or drone, (2) Capability to make measurements on specific types of signals or DL-RSs (e.g., SSB, CSI-RS, DM-RS, PRS, TRS, PTRS), (3) Capability to make measurements periodically and capable periodicity (e.g., 1 ms), (4) Capability to process and report the measurements to the network and capable processing duration, such as a minimum capable duration between the measurement and reporting (e.g., K symbols, slots, frames, subframes or ms, etc.), (5) Capability to report to the network periodically and capable periodicity (e.g., 1 ms), (6) Capability to perform measurements and sending reports that contain the measurements, (7) Capability to perform sensing-related measurements and sending reports that contain sensing related measurements, (8) Capability to perform sensing and communication, or (9) Capability on the number of cells or area(s) that the WTRU can support for sensing (e.g., make measurements on DL-RS from more than one cells), (10) WTRU location information and method used to determine the WTRU location information (e.g., determined based on GNSS, RAT dependent position), (11) Equipped hardware at the WTRU for sensing purpose or measuring the WTRU status (e.g., camera, infrared sensors, heat sensors, thermometer, gyroscope, speed sensor), or (12) Supported sensing type. Also, for example, the sensing type may include at least one of: sensing accuracy (e.g., maximum or minimum accuracy, measurement granularity), use case (e.g., detection, tracking, etc.), sensing measurement with and/or without WTRU positioning information, number of sensing measurement resources WTRU can perform simultaneously, or simultaneous sensing measurement and communication at the same and/or different frequencies support.

After sending the WTRU capability report, the WTRU may receive a request for sensing (e.g., reporting measurements to the network) from the network. The WTRU may send a response for the request to the network. If the WTRU accepts the request, the WTRU may receive configurations for DL-RS (e.g., PRS) to make measurements on. The WTRU may determine to make measurement report if trigger condition(s) for the measurement reporting are satisfied.

In one example, the WTRU may receive a request from the network (e.g., gNB, LMF) to report the WTRU location. For example, the WTRU may report its location using RAT independent positioning method (e.g., GNSS) and/or RAT dependent positioning method (e.g., DL-TDOA). The WTRU may indicate to the network the positioning method used to determine the WTRU location. The WTRU may receive the request for WTRU location before the WTRU reports sensing related measurements to the network. The WTRU may report the WTRU location after the WTRU receives a request to perform sensing related measurements.

In the examples described herein, “measurements” and “sensing related measurements” can be used interchangeably.

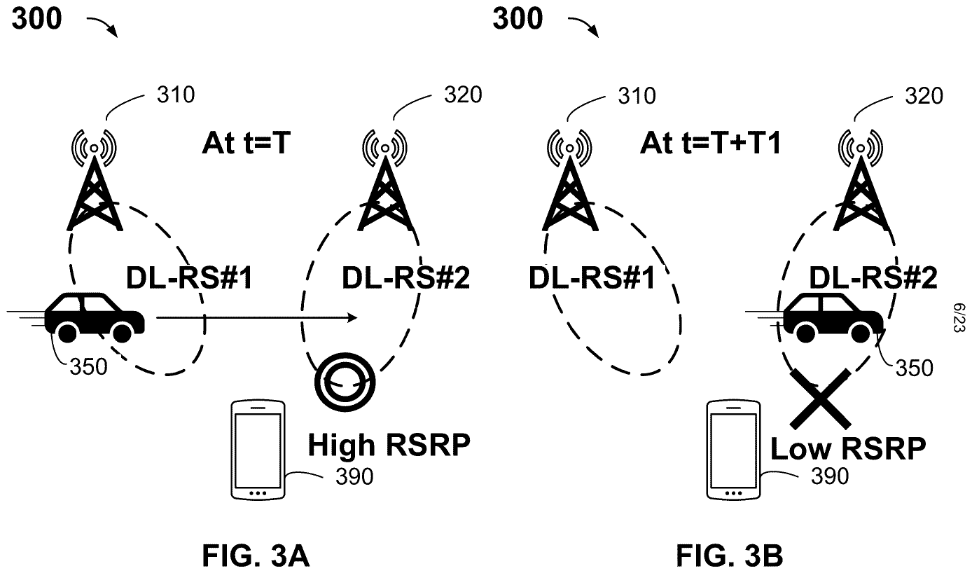

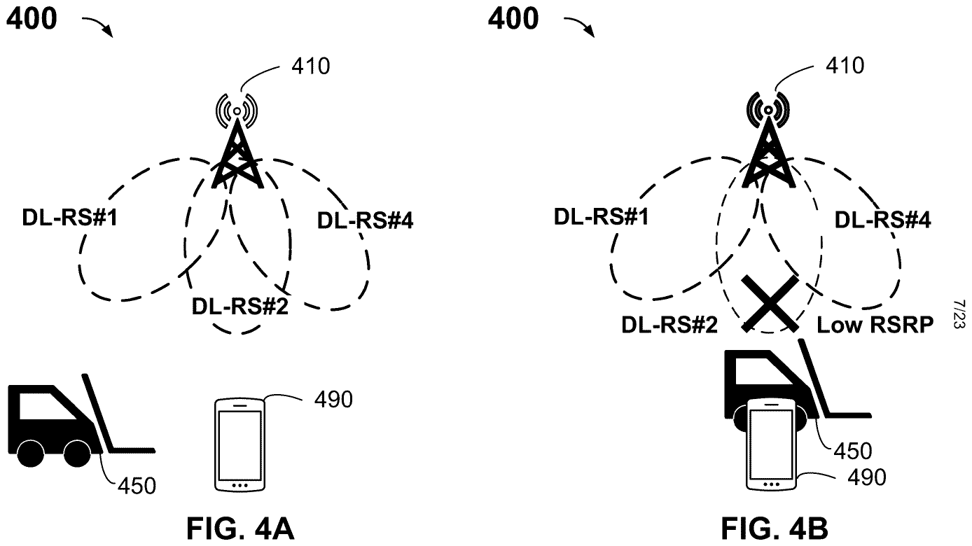

For example, an obstacle may block LOS of DL-RSs, degrading RSRP for the blocked DL-RSs (e.g., blocked DL-RSs). The NW may detect obstacles, and the NW may be able to predict DL-RSs that may be blocked. Examples of blockage and change in RSRP are illustrated in FIGS. 3A-3B and FIG. 4.

FIG. 3A is an example of a system 300 including down-link reference signals (DL-RSs) when an obstacle 350 is not blocking a beam between a WTRU 390 and two transmission reception points (TRPs) 310, 320, in accordance with one or more embodiments of the present disclosure. FIG. 3B is an example of the system 300 including the DL-RSs when the obstacle 350 is blocking a beam DL-RS #2 between the WTRU 390 and at least one of the two transmission reception points (TRPs) 320, in accordance with one or more embodiments of the present disclosure.

FIG. 4A is an example a system 400 including DL-RSs when an obstacle 450 is not blocking a beam between a WTRU 490 and a TRP 510, in accordance with one or more embodiments of the present disclosure. FIG. 4B is an example of the system 400 including the DL-RSs when the obstacle 450 is blocking a beam DL-RS #2 between the WTRU 490 and the TRP 410, in accordance with one or more embodiments of the present disclosure.

The beams may be blocked due to the presence of an obstacle. If the vehicle is slowly moving (e.g., cargo train), the beam blockage may last for a long time. The NW may want to find out more detailed characteristics of the target (e.g., human, vehicle, unmanned aerial vehicle, animal, automatic guided vehicle, object such as tree, box, etc.) as it passes between the TRP and WTRU. Conventional triggering conditions may not be done in a timely manner. As detailed herein, the NW is configured to provide such measurements in a timely manner.

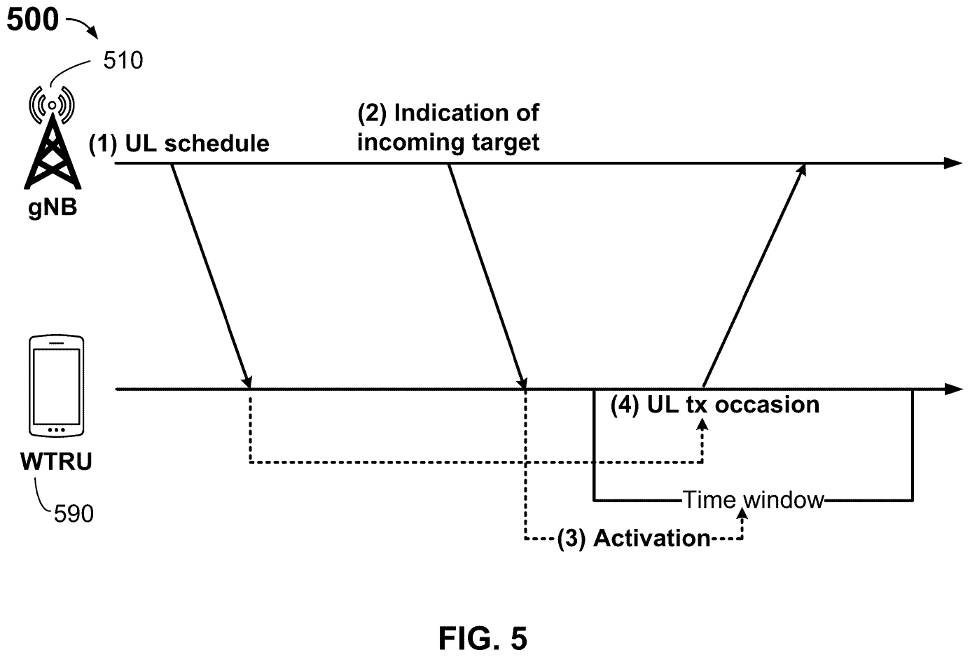

In some embodiments, a WTRU (e.g., 102, 390, 490, 590, 704, 1190, 1290, 1390, 1490, 1590, 1690, 1790, 1890, 2090, 2290) is configured with a time window (e.g., FIG. 5). FIG. 5 is an example of a sequence diagram 500 of communications aided by sensing results between a gNB 510 and a WTRU 590, in accordance with one or more embodiments of the present disclosure. The WTRU 590 receives (at step (1)) a UL transmission schedule (e.g., transmission of PUSCH) from the network. The WTRU 590 receives configuration for DL-RS to make measurements. The WTRU receives (at step (2)) an indication of incoming target(s) or notification of degradation of measurement. The indication also activates (at step (3)) the time window. If the scheduled UL transmission is inside the window and RSRP of the DL-RS is below the threshold, the WTRU determines to transmit (at step (4)) SRS to the network. Otherwise, the WTRU transmits the scheduled PUSCH.

In some embodiments, the WTRU 590 receives configuration for DL-RS for sensing. Also, for example, the WTRU 590 is configured with a time window. Further, for example, the WTRU 590 receives configurations for SRS. In addition, for example, the WTRU 590 is scheduled with UL resources for transmission for UL channels (e.g., PUSCH). Moreover, for example, the WTRU 590 receives notification from the network that the target is coming, activating a time window. Furthermore, for example, the WTRU 590 performs one or more determinations for the scheduled UL transmission. Additionally, for example, if the scheduled UL resource is within the time window and measurement for the DL-RS (made during the window) satisfies the condition (e.g., RSRP below the configured threshold), the WTRU 590 determines to transmit SRS in the scheduled UL resource. Still further, for example, if the scheduled UL resource is within the time window and measurement of the DL-RS does not satisfy the condition, the WTRU 590 transmits the scheduled PUSCH. Even further, for example, if the scheduled UL resource is outside of the time window, the WTRU 590 determines to transmit the scheduled PUSCH. Yet further, for example, the WTRU 590 reports measurements of the DL-RS to the network.

In various embodiments, communications are aided by sensing results. For example, the communications aided by sensing results include at least one of detailed measurements, association of sensing measurements and communication measurements, primary and secondary configurations, entry and exit conditions, event-based sensing, or WTRU measurement reporting behavior.

For example, measurements using reference signal details are provided. In some embodiments, the WTRU may receive a request, from the wireless network (e.g., LMF or gNB), to report measurements for the received DL-RSs. The wireless network may process the measurements to determine the location of a sensing target (e.g., a car, a drone, a human, an automated guided vehicle, or an environmental object). In some embodiments, the WTRU may receive a request to report at least timing measurements, power measurements and/or phase measurements for the configured DL-RS the WTRU receives from a TRP. Each of the measurements (e.g., timing measurements, power measurements, or phase measurements) may be defined relative to a reference value (e.g., a reference timing, reference power, or reference phase). For example, the timing measurement may be timing relative to a reference timing (e.g., the first path, the earliest DL-RS, the first detected path or the first detected DL-RS). In another example, power measurements may be defined relative to a reference power (e.g., power of the first detected path). In some embodiments, phase measurements may be defined relative to a reference phase (e.g., phase of the first detected path).

In some embodiments, the WTRU may receive a request to make measurements and report the measurements for sensing purposes. In response to receiving the request, the WTRU may send a response to the wireless network, either accepting or rejecting the request. Furthermore, the WTRU may send a cause for the response when rejecting the request (e.g., the WTRU is mobile or the WTRU's battery power is low).

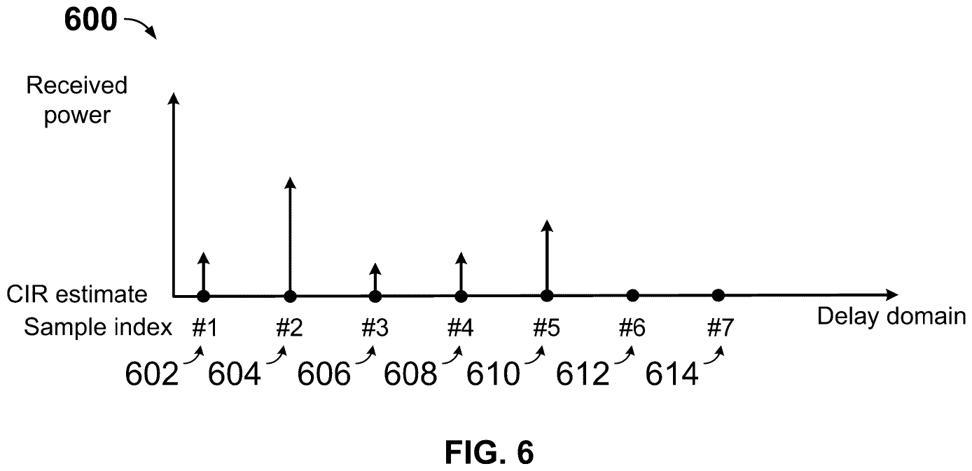

FIG. 6 shows an illustrative graph of example CIR estimate 600, in accordance with one or more embodiments of the present disclosure. In some embodiments, the WTRU may obtain a CIR estimate 600 for the received OFDM symbol. The CIR estimate 600 shown in FIG. 6 includes seven samples (e.g., first sample 602, second sample 604, third sample 606, fourth sample 608, fifth sample 610, sixth sample 612, and seventh sample 614). The WTRU may receive, from the wireless network, the number of samples for CIR estimates (e.g., CIR estimate 600). The WTRU may report measurements (e.g., timing, power, or phase) or measurements per sample when the measurements (e.g., RSRP) corresponding to the sample (e.g., first sample 602, second sample 604, third sample 606, fourth sample 608, fifth sample 610, sixth sample 612, and seventh sample 614) is above a (e.g., configured) threshold.

The WTRU may receive a request from the wireless network to report the CIR estimate 600. In some embodiments, the WTRU may report one or more samples corresponding to at least one measurement (e.g., received power) is above a threshold (p_{threshold}). The WTRU may indicate measurements (e.g., power, phase) and relative timing of the sample (e.g., first sample 602, second sample 604, third sample 606, fourth sample 608, fifth sample 610, sixth sample 612, and seventh sample 614) with respect to a reference timing. In some embodiments, the WTRU may report an OFDM symbol index at which the CIR estimate 600 is obtained. In addition, a slot index, a frame index, a subframe index and/or a SFN which includes the OFDM symbol may be reported by the WTRU. The WTRU may determine to report an average of the CIR estimates (e.g., including CIR estimate 600). In such embodiments, the WTRU may report, to the wireless network, the number of OFDM symbols used to determine the average of the CIR estimates. In addition, the WTRU may report a location of the OFDM symbols (e.g., symbol index, slot index, frame index, subframe index, SFN) used to determine the average CIR.

In some embodiments, the WTRU may receive a request to report N CIR estimates (e.g., CIR estimate 600) within a configured duration (e.g., one slot). In such embodiments, the WTRU may determine a CIR estimate (e.g., CIR estimate 600) per OFDM in the configured duration. The WTRU may determine to report N number of the CIR estimates (e.g., CIR estimate 600) based on a criterion (e.g., CIR estimates corresponding to the N highest RSRP).

In addition to the measurement, the WTRU may report the corresponding sample index for the measurement (e.g., a sample index corresponding to one of the first sample 602, second sample 604, third sample 606, fourth sample 608, fifth sample 610, sixth sample 612, and seventh sample 614). In one example, the WTRU may receive an indication to use an earliest sample as the reference timing (e.g., first sample 602 as shown in FIG. 6). In another example, the WTRU may receive a request to use the sample corresponding to the highest power as the reference timing (e.g., second sample 604 in FIG. 6). The WTRU may receive a time or sample offset, e.g., Noffset, to indicate the sensing target timing. For example, when Noffset=4 samples from the reference timing of sample, if the sensing target sample is second sample 604, the sensing target sample is sixth sample 602. In some embodiments, the WTRU may receive more than one time or sample offsets (e.g., Noffset), indicating a range of sensing target timing and/or samples or more than one sensing target timing or samples. For example, Noffset=[4,6] indicates sensing target samples that are 4, 5 and 6 samples from the reference timing or sample. In such an example, the WTRU may determine to make measurements (e.g., timing measurement, power measurement, or phase measurement) for the indicated range of samples or one or more sensing target timing and/or samples.

Although the examples herein use OFDM symbols, the present disclosure is not limited to the use of OFDM symbols, and is applicable to any type of symbols, such as DFT-spread OFDM, or single carrier signals.

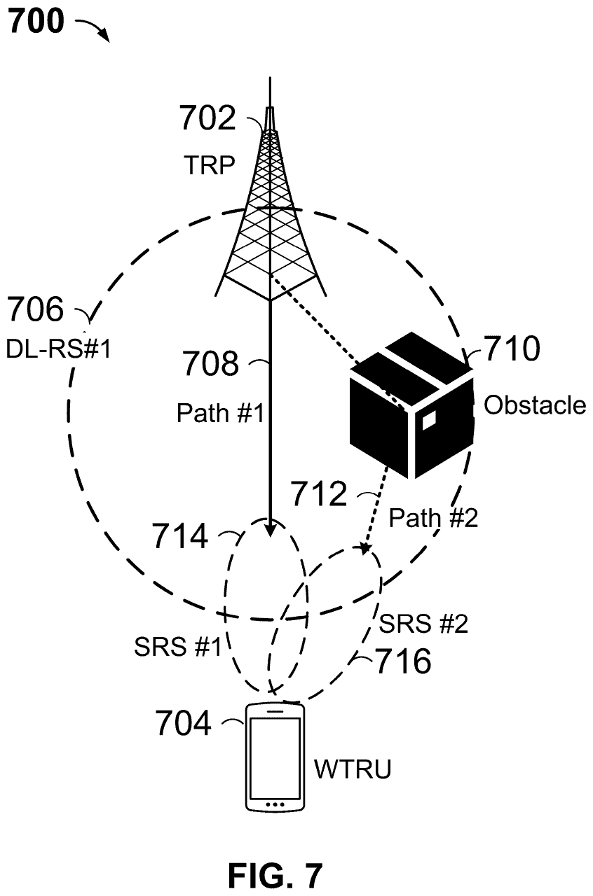

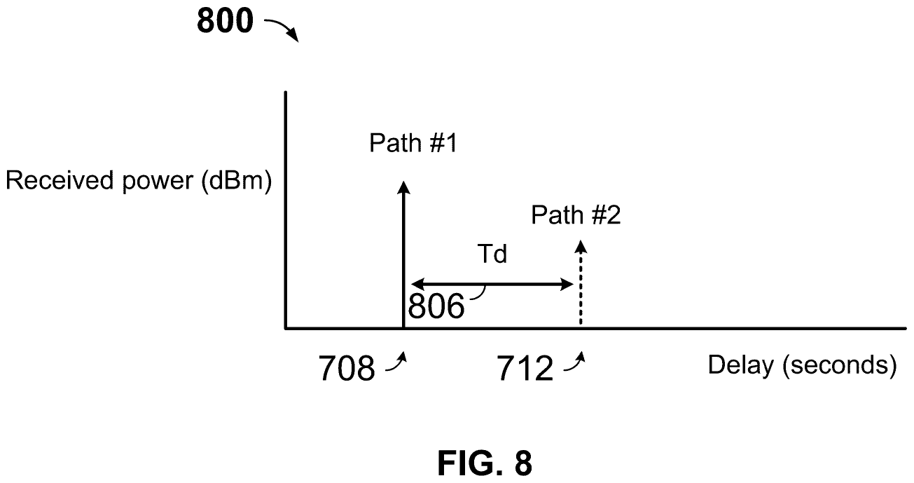

FIG. 7 shows an illustrative example of a multi-path channel 700 with WTRU 704 and wireless network (e.g., via TRP 702) showing a spatial relationship between a DL-RS 706 and an UL-RS that may be used within the communications system illustrated in FIG. 1A. Additionally, FIG. 8 shows an illustrative graph of an example multi-path delay profile 800 showing received power for direct path 708 and indirect path 712 of FIG. 7, in accordance with one or more embodiments of the present disclosure.

The WTRU 704 may receive DL-RS 706 from the TRP 702. As illustrated in FIG. 7, the transmitted signal may reflect against an obstacle 710 and creates an additional path (e.g., an indirect path 712). Therefore, the WTRU 704 receives two paths, direct path 708 and indirect path 712 where the indirect path 712 arrives Td seconds (e.g., time difference 806) later than direct path 708. In some embodiments, the obstacle 710 that creates the indirect path 712 may be referred to as a “sensing target”. In some embodiments, the wireless network or WTRU 704 may determine the location of the obstacle 710 based on measurements (e.g., timing measurements, power measurements, and/or measurements).

In some examples, the WTRU 704 may receive a request, from the wireless network (e.g., LMF or gNB), to report measurements. The WTRU 704 may receive a request, from the wireless network, to associate measurement information to the RS and/or RS parameters (e.g., DL-RS parameters or UL-RS parameters). In some embodiments, the WTRU 704 may receive a request to associate a type of measurement to the RS (e.g., angle measurement to the RS). For example, the WTRU 704 may determine to associate an AoA of the received DL-RS to the AoD of an UL-RS.

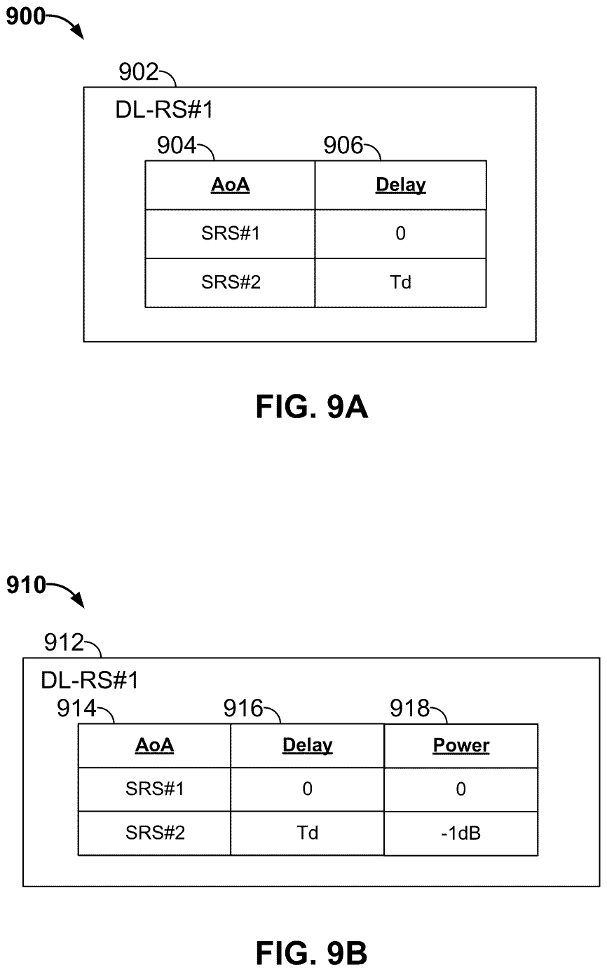

FIGS. 9A-9B show examples of WTRU report content (e.g., 900 and 910), in accordance with one or more embodiments of the present disclosure. Examples of measurement reports (e.g., 902 and 912) that the WTRU sends to the wireless network is shown in FIGS. 8 and 9. The WTRU may report AoA (e.g., AoA 904 and AoA 914) and timing information (e.g., delay 906 and delay 916) for each detected path. The AoA (e.g., AoA 904 and AoA 914) may be reported in terms of degrees or radians. The AoA (e.g., AoA 904 and AoA 914) may be reported in terms of UL-RS (e.g., SRS) configured to the WTRU, implying that the measured AoA (e.g., AoA 904 and AoA 914) is similar to or equivalent to an AoD of the indicated SRS (e.g., first SRS 714 or second SRS 716, as shown in FIG. 7). In some embodiments, the direct path 708 is aligned with AoD of the first SRS 714 and the indirect path 712 is aligned with AoD of the second SRS 716. As shown in FIGS. 7 and 9A-9B, “SRS #1” and “SRS #2” indicate identification of the SRSs (e.g., first SRS 714 and second SRS 716) transmitted by the WTRU 704. In some embodiments, the SRSs (e.g., first SRS 714 and second SRS 716) may be indicated as identification information in the configuration, e.g., using SRS resource index or SRS ID. Using the reports (e.g., reports 902 and 912), the WTRU 704 may report to the wireless network that the indirect path 712 arrives Td seconds later than the direct path 708. In some embodiments, WTRU 704 may determine to associate an SRS (e.g., first SRS 714 or second SRS 716) and DL-RS based on a spatial filter used to transmit or receive the SRS or DL-RS, respectively. For example, WTRU 704 may use the same or a similar spatial filter to transmit the SRS or receive the DL-RS.

In one example, the WTRU may determine to associate an SRS and DL-RS based on the spatial filter used to transmit or receive the SRS or DL-RS, respectively. For example, the WTRU may use same or similar spatial filter to transmit or receive the SRS or DL-RS, respectively.

As shown in FIG. 9B, the WTRU may report AoA 914, timing information (e.g., delay 916) and power information 918 for each detected path (e.g., first SRS 714 and second SRS 716). In embodiments where there are two or more paths (e.g., two or more SRSs), the WTRU reports timing information (e.g., delay 916) and power information 918 relative to a reference timing and reference power. In some embodiments, the reference timing and reference power are associated with the direct path 708. For example, as shown in FIG. 9B, the power received for the indirect 712 path is 1 dB less than the power received for the direct path 708. In some examples, the measurement report (e.g., measurement reports 902 and 912) may be referred to as a “power-delay-spatial” report.

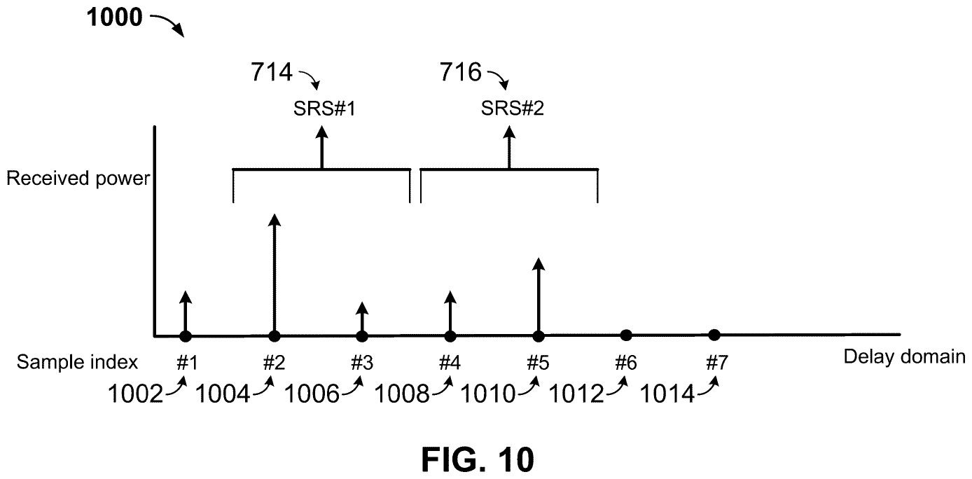

FIG. 10 shows an illustrative graph 1000 of example paths associated to sample-based measurements, in accordance with one or more embodiments of the present disclosure. In one example, the WTRU may determine to associate UL-RS information to one or more samples (e.g., first sample 1002, second sample 1004, third sample 1006, fourth sample 1008, fifth sample 1010, sixth sample 1012, and seventh sample 1014) in the sampled based measurement report. For example, the WTRU may be configured to report RSRP per sample, where the first sample 1002 may be the first detected path from the received DL-RS. In some embodiments, the WTRU may associate or indicate a respective AoA for each sample of the samples or a set of samples with an RSRP that is greater than a configured power threshold. For example, as shown in FIG. 10, the WTRU may indicate one or more samples, each of which have a respective AoA that corresponds to an AoD of the configured UL-RS (e.g., first SRS 714 for the AoA of second sample 1004 and third sample 1006, or second SRS 716 for the AoA of fourth sample 1008 and fifth sample 1010). Although each of first SRS 714 and second SRS 716 each include two samples, an SRS may include one sample or more than two samples.

The WTRU may determine to indicate, to the wireless network, a change in a reference SRS in the measurement report. For example, the reference SRS may be used to determine relative timing, relative power or relative phase measurement for other SRSs included in the measurement report. In some embodiments, the WTRU may report the reference SRS when the WTRU determines to use a new reference SRS (e.g., a DL-RS used to determine relative measurements for timing, power, and phase). The WTRU may further report the sample index or path index corresponding to each relative timing measurement, relative power measurement, or relative phase measurement. In one example, the WTRU may be configured to report any association between a previous reference SRS and a new reference SRS to the wireless network. An example of an association may be any measurement offset or difference in the respective measurement of the new reference SRS compared to the old reference SRS. For instance, the WTRU may determine a first path (e.g., LoS path) as an old reference for relative timing measurement and a second path as a new reference for timing measurement. The association between the references may be relative timing of the new reference with respect to the old reference.

In some embodiments, the WTRU may be configured to change the reference (e.g., SRS reference) and/or report the measurements (e.g., only) when the WTRU determines an association between the old reference (e.g., previous reference SRS) and the new reference (e.g., new reference SRS). The association may enable the wireless network or the WTRU to use measurements with each of the old reference and the new reference for sensing. In some embodiments, WTRU may be configured to terminate any performance of sensing if the WTRU cannot determine an association between the new reference (e.g., new reference SRS) and the old reference (e.g., previous reference SRS).

The WTRU may be configured to transmit a report including at least one of the following to the wireless network: (a) one or more measurements (e.g., associated with a new reference SRS), (b) an indication (e.g., binary flag) of whether the reference (e.g., reference SRS) has changed when compared to a previous measurement report, (c) a new reference (e.g., a new reference SRS), (d) an old reference (e.g., a previous reference SRS), or (e) an offset or difference between the new reference and old reference (e.g., a measurement of new reference SRS relative to the old reference SRS), or a combination thereof.

For example, association of sensing measurements and communication measurements is provided. Association can be established between beam measurements and sensing measurements. For example, associate Channel Quality Indicator (CQI) and/or Precoding Matrix Indicator (PMI) with sensing measurements (e.g., multipath measurements) when the WTRU detects degradation in CQI. The sensing measurements may be obtained using different DL-RSs dedicated for sensing RSs.

Sensing measurements or metrics can include at least one of the following: CIR, PDP, DP, Power measurements (e.g., RSRP, RSRPP), Time difference measurements, or Phase difference measurements.

Communication measurements or metrics can include at least one of the following: PMI, CQI (Channel quality indicator), or RSRP (e.g., L1-RSRP, L2-RSRP, L3-RSRP).

For example, criteria and conditions for association of two types of measurements are provided. The WTRU may be configured to make two types of measurements, e.g., measurements for sensing and communication. The WTRU may determine to associate two types of measurements based on a condition (e.g., request from the network).

In one example, the WTRU may be configured to associate two types of measurements, e.g., first and second measurement. An example of first measurement may be sensing measurement. An example of second measurement may be measurements used for communication (e.g., CSI measurement).

In one example, the WTRU may be configured to associate sensing measurements and CSI measurements. In this disclosure, the term “association” between sensing and CSI measurements may mean association in measurements (e.g., sensing measurement and CSI measurement), processing and/or reporting.

In one example, the WTRU may receive configurations to make sensing and/or communication measurements. The WTRU may receive CSI configurations for measurements for communication. The WTRU may receive DL-RS configurations for measurements for sensing.

In one solution, the WTRU may receive the indication to perform sensing measurements in CSI configuration (e.g., CSI resource configuration, CSI report configuration, etc.). The WTRU may receive an indication to associate sensing measurements and CSI measurements based on indication from the network (e.g., lower layer indications such as with DCI or MAC-CE or higher layer indications such as with RRC signaling).

An example of such indication for association may be an indication (e.g., a bitfield, a flag, etc.) in the trigger (e.g., DCI trigger, MAC-CE trigger) for CSI to associate and report the sensing measurements. Another indication for the association may be an indication (e.g., a bitfield, a flag, etc.) in the trigger (e.g., DCI trigger, MAC-CE trigger) for sensing to associate and report the CSI measurements. Another example may be an indication in the CSI configuration and/or sensing configuration to associate and report the CSI measurements with the sensing measurements.

In one solution, the WTRU may be configured to associate at least one sensing measurement with at least one CSI reporting quantities. For example, the WTRU may be configured to report at least one of the CSI report quantities such as CQI, PMI, RSRP, Rank Indicator (RI), etc. based on DL-RS (e.g., SSB, CSI-RS, etc.) measurement associated with at least one sensing measurement (e.g., power measurement (e.g., RSRPP), time measurement (e.g., path delay relative to a reference), angle measurement (e.g., AoA, AoD), phase measurement (e.g., phase difference), CIR, PDP, DP, etc.).

An example of association may be association of the same type of measurements or quantities between the two reports. In one solution, the WTRU may be configured to associate at least one of the following between the CSI and sensing measurements: (1) the RI (e.g., CRI, SSB-RI) for based on CSI measurement (e.g., maximizing the SINR or SNR) associated with at least one resource based on the sensing measurement (e.g., maximizing the power measurement associated with a sensing path), (2) at least one sensing measurement (e.g., RSRPP, RSRP etc.) associated with the L1-RSRP quantity in the CSI report. In one example, the WTRU may determine to associate RSRP in the CSI report to the RSRP for DL-RS for sensing. The WTRU may determine to indicate the association by associating the CSI-RS resource index and DL-RS resource index for sensing, or (3) at least one quality indication (e.g., timing quality, angle quality, SINR quality, etc.) associated with sensing measurement associated with at least one CQI value based on CSI measurement, etc.

In one example, the WTRU may be configured to associate and report at least one sensing measurement (e.g., time delay measurement, angle measurement, PDP, DP, etc.) and at least one of the same CSI measurements (e.g., time delay measurement, angle measurement PDP, DL, etc. respectively) based on the DL-RS (e.g., SSB, CSI-RS, etc.) configured for CSI reporting. An example of association may be the CSI and sensing measurements corresponding to the same path.

In another example, the WTRU may be configured to associate the measurements based on same level of processing. For instance, (1) The WTRU may be configured to associate a level of measurement (e.g., L1, L2, L3, etc.) with the associated level of measurement for sensing (e.g., L1, L2, L3, etc. respectively). For example, the WTRU may be configured to associate CSI and sensing measurements at the same or different level. For example, the WTRU may determine to associate L1 sensing measurements to L3 measurements for communication and report the associated measurements to the network. By reporting the first type of measurement (e.g., sensing measurement) at lower level compared to the second type of measurement (e.g., communication measurement), the WTRU can provide more details about the second type of measurement. (2) The WTRU may be configured to associate measurements (e.g., CSI measurements and sensing measurements) corresponding to an associated no. of samples (e.g., same no. of samples). (3) The WTRU may be configured to associate measurements performed in the associated time instances, for e.g., same slot, frame, subframe, etc. Or, (4) The WTRU may be configured to associate measurements performed in the associated frequency resources (e.g., same BWP, positioning frequency layer, carrier, band etc.).

In one solution, the WTRU may be configured to associate measurements between a sensing resource and a CSI resource based on at least one or combination of the following: (1) The WTRU receives an indication of the resource(s) from the network, (2) The WTRU is configured or receives a request from the network (e.g., LMF, gNB) to associate measurements for communication and sensing, (3) The WTRU receives configuration(s) (e.g., thresholds) to associate measurements for communications and sensing, or (4) The WTRU determines an association between the resource configuration for CSI measurements and sensing measurements. For example, the association may be at least one of the following: (a) a QCL (e.g., type D) association between DL-RS for sensing and CSI measurements, (b) Same resource ID or resource set ID (e.g., CSI-RS, SSB, etc.) for sensing and CSI measurements, etc., (c) Same or overlapping (e.g., complete or partial overlap) frequency resource(s) for sensing and CSI measurements, such as same or overlapping DL-BWP, PFL, RBs, etc., (d) The duration between the measurement occasions (e.g., in terms of no. of symbols, slots, sub-frames, frames) is below a (pre) configured threshold, etc., or (e) The CSI measurement and/or reporting occasions are within a configured time window (e.g., for sensing), etc.

In one solution, the WTRU may be configured to determine and/or report at least one of the CSI reporting quantities based on sensing measurements.

In one solution, the WTRU may be configured to determine report the reliability of CSI measurements to the network. An example of this may be if the WTRU determines a CSI measurement quantity with a first resource indicator (e.g., CRI) and a first CQI based on CSI measurements, the WTRU may determine whether the determined values are reliable or not based on sensing measurements. If the determined resource and the corresponding CQI are associated with a path through a mobile object (e.g., a large vehicle), the WTRU may determine to report a second resource and CQI based on the determination that the report may not be reliable. In these examples, the reliability may be an indicator for the confidence value of the CSI measurement.

Likewise, the WTRU may be configured to report the reliability of the CSI measurements to the network. The examples of reliability may be at least one of the following: a CSI reporting quality validity duration (e.g., in no. of symbols, slots, frames, subframes, ms, etc.) indicating duration (e.g., relative to a reference such as measurement time or reporting time instance) where the reporting quantity may be valid, or a CSI reporting quantity confidence indicator (e.g., in terms of percentage, hard indicator, soft indicator) indicating the determined confidence of the quantity, etc.

One reliability may be reported for one reporting quantity or for more than one reporting quantity.

For example, the WTRU may determine the reliability based on at least one of the following: (1) At least one sensing measurement (e.g., associated with at least one sensing path, sensing target, EO, etc.), (2) At least one CSI measurement, (3) The difference between at least one measurement such as sensing measurement (e.g., associated with at least one sensing path, sensing target, EO, etc.) and/or CSI measurement, (4) At least one statistic (e.g., variance) of a sensing measurement and/or a CSI measurement, (5) Sensing target (e.g., EO) mobility, or (6) WTRU mobility, etc.

The WTRU may be configured to indicate, in the report, whether at least one CSI reporting quantity is determined based on at least one sensing measurement.

In one solution, the WTRU may be configured to report the CSI measurement only if the quality indicator is above or below a (pre) configured threshold.

In one solution, the WTRU may be configured to report both sensing measurements and CSI measurements jointly, for e.g. in the same report. The WTRU may report the CSI report along with the associated sensing measurements in an uplink resource (e.g., PUCCH, PUSCH, via UCI, or MAC-CE).

In another solution, the WTRU may be configured report the CSI measurements and sensing measurements independently by the network, but with an association, where the association may be based on at least one of the following: (1) DL-RS ID (e.g., SSB, CSI-RS, DL-PRS ID) associated with the measurement, (2) Timestamp associated with the sensing and CSI measurements, (3) Reporting ID for e.g., sensing report and/or CSI report ID, (4) Configuration ID associated with the measurements, for e.g., DL-RS configuration ID, measurement configuration ID, or (5) A flag (e.g., 0, 1) indicating if there is an association between sensing and CSI measurements etc.

In one solution, the WTRU may report association between sensing report and/or CSI report.

In one example, if reported independently, the sensing and the CSI report may both be reported to the same entity such as the gNB, or to different entities, such as sensing report to a core network entity handling sensing function (e.g., sensing management function, LMF, etc.) and CSI report to the gNB.

In one solution, the WTRU may be configured to associate the sensing measurements and the CSI measurements if at least one sensing measurement is indicated as a triggering condition for CSI measurement and/or reporting. The WTRU may be configured with at least one of the following conditions associated with sensing measurement as a trigger condition for CSI reporting: (1) At least one sensing measurement is above or below a (pre) configured threshold, (2) The difference between at least one measurement (e.g., between measurement occasions, DL-RS resources, etc.) is above or below a (pre) configured threshold, (3) The statistic (e.g., variance) of at least one sensing measurement is above or below a (pre) configured threshold, (4) Sensing target mobility (e.g., change in location, rate of change of location, velocity, acceleration) is above or below a (pre) configured threshold, (5) WTRU mobility (e.g., change in location, rate of change of location, velocity, acceleration) is above or below a (pre) configured threshold, or (6) The determined measurement reliability is above or below a (pre) configured threshold, etc.

In another example, the WTRU may be configured to associate the sensing measurements and CSI measurements if at least one CSI measurement is configured as at least one of the trigger conditions associated with measurement and/or reporting of sensing measurements. For e.g., the triggers for sensing measurement or reporting may be at least one of the following: (1) At least one of the measurement quantity associated with CSI measurement (e.g., CQI, L1-RSRP etc.) is above or below a (pre) configured threshold, (2) The difference between at least one measurement quantity associated with CSI measurement is above or below a (pre) configured threshold, (3) At least one CSI measurement quantity changes (e.g., RI, PMI, etc.), (4) At least one statistic (e.g., variance) associated with the CSI measurement is above or below a (pre) configured threshold, etc., or (5) The WTRU is configured or receives a request from the network to make sensing measurements during a configured time window(s) and make CSI measurements outside of the window.

The WTRU may be configured to stop the association between the sensing measurement and CSI measurement based on at least one of the following: (1) The WTRU receives an indication to stop the association (e.g., via DCI, MAC-CE, etc.), (2) The WTRU determines the expiry of a window (e.g., configured sensing window), (3) The WTRU receives an indication to terminate at least one of the procedures (e.g., sensing, CSI measurement), or (4) The WTRU determines that at least one of the trigger conditions (e.g., for sensing reporting and/or CSI reporting) are not satisfied etc.

For example, primary and secondary configurations are provided. Also, for example, primary and secondary TCIs are provided. Further, for example, the WTRU is configured with a first and second TCI. The WTRU may be configured to use the first TCI. The WTRU may determine to activate the second TCI and deactivate the first TCI based on a condition. The WTRU may determine to track QCL if mobility of the target is detected.

For example, a condition-based TCI update mechanism based on primary and/or secondary TCIs is provided. In a solution, the WTRU may receive a first indication (e.g., by a DCI and/or MAC-CE) of a first TCI-state (e.g., as a primary TCI) to be used for DL receptions and/or UL transmissions. The WTRU may receive a second indication (e.g., by a DCI and/or MAC-CE) of a second TCI-state (e.g., as a secondary TCI, as a backup TCI) to be used for DL receptions and/or UL transmissions when (e.g., only when) at least one of following conditions is met: (1) When the NW explicitly indicates to use (e.g., apply) the secondary (or backup) TCI, e.g., via a separate DCI and/or MAC-CE signaling, e.g., based on that the NW detects obstacles, based on the positioning technique and/or an indication from the LPP, PRU, etc., (2) Based on the WTRU's measurement results such as the sensing measurements and/or communication measurements, where the WTRU may use (e.g., apply, switch to) the secondary (or backup) TCI for DL receptions and/or UL transmissions (e.g., a particular group of DL receptions and/or UL transmissions) when at least one of the measurement results (e.g., RSRP, layer-1 (L1)-RSRP, SINR, L1-SINR, CQI, etc.) is lower than a (configured) threshold. The WTRU may receive a time-domain offset parameter, where the WTRU perform the switching to the secondary TCI after the offset parameter upon determining the measurement results. Or, (3) Based on the WTRU's reporting associated with the measurement results such as the sensing measurements and/or communication measurements, where the WTRU may receive a second time-domain offset parameter, where the WTRU perform the switching to the secondary TCI after the second offset parameter upon reporting the measurement results.

In an example, the particular group of DL receptions and/or UL transmissions may be based on (e.g., associated with) at least one of the following, where the WTRU may receive information related to such applicable physical channel or signal (or one or particular types of a physical channel or signal) to apply the secondary (or backup) TCI: (1) A PUSCH (e.g., all types of PUSCH, or one or more particular types of PUSCH), e.g., (a) A configured grant (CG)-PUSCH (or further specific to a particular Tx type, e.g., a Type-1 CG-PUSCH, a Type-2 CG-PUSCH, etc.), or (b) A dynamic grant (DG) PUSCH, (2) A PUCCH (e.g., all types of PUCCH, or one or more particular types of PUCCH), e.g., (a) A PUCCH carrying CSI reporting contents (e.g., a PUCCH carrying a UCI), and/or (b) A PUCCH carrying a HARQ-ACK, (3) An SRS (e.g., all types of SRS, or one or more particular types of SRS), e.g., (a) An SRS resource, (b) An SRS resource set, (c) An SRS configuration (e.g., ‘SRS-config’) that may comprise one or more SRS resource sets (or, one or more SRS resources), or (d) A group of SRS resources associated with a (e.g., same) ‘usage’ parameter, e.g., indicating at least one of {CB, NCB, BM, AS}, (4) A PRACH (e.g., all types of PRACH, or one or more particular types of PRACH), e.g., (a) A group of PRACHs, associated with (e.g., used for) a contention-based random access (or a contention-free random access), or (b) A group of PRACHs, associated with (e.g., used for) a 4-step RACH procedure (or a 2-step RACH procedure), (5) A PDSCH (e.g., all types of PUSCH, or one or more particular types of PUSCH), e.g., (a) A semi-persistent-scheduling (SPS)-PDSCH (or further specific to a particular type of SPS-PDSCH, if configured), or (b) A dynamic grant (DG) PDSCH, (6) A PDCCH (and/or CORESET) (e.g., all types of PDCCH (and/or CORESET), or one or more particular types of PDCCH (and/or CORESET)), e.g., (a) A group of PDCCH types, (b) A group of cell-common PDCCHs (e.g., that may be associated with a cell-specific search space (set)), (c) A group of WTRU-specific PDCCHs (e.g., that may be associated with a WTRU-specific search space (set)), (d) PDCCH associated with a particular group of search spaces (or search space sets), or (e) PDCCH associated with a particular group of CORESETs (e.g., a special CORESET, CORESET #0, CORESET #0 that may be used for initial access, a CORESET that is configured as a part of beam failure recovery procedure), (7) An CSI-RS (e.g., all types of CSI-RS, or one or more particular types of CSI-RS), e.g., (a) A CSI-RS resource, (b) A CSI-RS resource set, (c) A CSI-RS configuration (e.g., ‘CSI-RS-config’) that may comprise one or more CSI-RS resource sets (or, one or more CSI-RS resources), (d) A group of CSI-RS resources associated with a (e.g., same) particular usage, e.g., applicable for beam management, mobility management, and/or RRM, etc., or (e) A group of CSI-RS resources for tracking (e.g., tracking RS (TRS)), (8) A demodulation RS (DMRS) (e.g., all types of DMRS, or one or more particular types of DMRS), or (9) A phase-tracking RS (PTRS) (e.g., all types of PTRS, or one or more particular types of PTRS).

The WTRU may, at time T1 (as an entry condition), start using the secondary (or backup) TCI for DL receptions and/or UL transmissions (e.g., the particular group of DL receptions and/or UL transmissions), instead of using the primary TCI which has been used before T1.

The WTRU may receive a third time-domain offset parameter (by a configuration or an indication), where the WTRU may determine, e.g., as an exit condition, to use again (e.g., fallback) the primary TCI after the third offset parameter (e.g., timer and/or time-window) has elapsed, since using the secondary TCI. This may provide benefits in terms of reducing signaling overhead and/or improving efficiency and flexibility of TCI controls, based on that the NW does not need to explicitly indicate to fallback to use the primary TCI, e.g., based on the prediction results via sensing the obstacles (e.g., shown as examples of FIG. 2 and FIG. 3) where the NW may predict a time instance on when the obstacle does not exist any longer.

In a solution, the WTRU may (be configured to) store (e.g., keep storing, keep maintaining, keep tracking) one or more determined (e.g., measured, derived) QCL properties (e.g., at least one of typeA, typeB, typeC, and typeD) measured on the primary TCI while the WTRU switched to use the secondary TCI, until the third offset parameter has elapsed. This may provide benefits in terms of reducing latency and improving robustness in applying the primary TCI after the fallback, based on that the WTRU does not flush out (e.g., remove, reset) the determined QCL property(es) even though the indicated TCI-state has switched to the secondary TCI. In an example, if the WTRU receives an TCI-state indication which is not based on the primary and/or secondary TCI, the WTRU may apply the indicated TCI-state and does not store QCL property(es) on the previous TCI-state.

For example, QCL tracking is provided. In one example, the WTRU may be configured to track QCL information for the indicated DL-RS, DL channel, UL-RS, UL channel and/or TCI. The WTRU may be configured to track an indicate type(s) of QCL (e.g., typeA, typeB, typeC, and/or type D, spatial relationship). The WTRU may be configured with a time window during which the WTRU is expected to track QCL information. In another example, the WTRU may be configured with periodicity (e.g., every 1 ms, every slot, every frame) at which the WTRU may determine QCL information for the indicated DL-RS, UL-RS and/or TCI. The WTRU may be configured to report determined QCL information at each periodic occasion to the network. For example, the WTRU may be configured to track QCL type D for CSI-RS #2 at configured timing occasions, T1, T2 and T3. The WTRU may determine that QCL type D for CSI-RS #2 is CSI-RS #3, CSI-RS #4 and CSI-RS #5 at t=T1, T2, and T3, respectively.

In another example, the WTRU may report QCL information if there is a change to QCL information. For example, the WTRU may record QCL information for type D when there is a change in AoA of the indicated DL-RS. The WTRU may be configured to report QCL information for the indicated DL-RS and the WTRU may determine to report the recorded QCL information. The WTRU may include a timestamp in the measurement report. The timestamp can indicate the time when the WTRU reports the QCL information. In another example, the timestamp can indicate timing at which QCL information changed (e.g., AoA changed).

In another example, the WTRU may be configured to update QCL information for at least one DL-RS, DL channel, UL-RS, UL channel and/or the (e.g., associated) TCI state or TCI-UL state if any metric (e.g., SNR, SINR, throughput, retransmission, a measurement) associated with the DL-RS changes. The WTRU may be configured to determine the updated association based on at least one sensing measurement and/or at least one processed sensing result (e.g., presence of a sensing tor an EO target associated with the DL-RS, or UL-RS). The WTRU may be configured to report the DL-RS, the UL-RS, DL channel, UL channel and/or the updated QCL relationship and the reason for update (e.g., change in metric) to the network.

In one example, the WTRU may not be able to determine QCL information for the indicated DL-RS due to the mismatch between actual channel measurement (e.g., Doppler, angle of arrival) and available QCL information (e.g., DL-RS or UL-RS resource index or ID that the WTRU can refer to). If the WTRU cannot determine QCL for the indicated DL-RS, the WTRU may determine to report numerical information (e.g., angle of arrival, estimated Doppler shift, Doppler spread, etc.) for the indicated DL-RS. The WTRU may report the cause of reporting of numerical information to the network (e.g., mismatch between the actual measurement and available references).

In another example, the WTRU may receive an indication or request from the network to report QCL information based on configured references (e.g., DL-RS resource ID) or numerical information (e.g., estimated Doppler shift, estimated AoA or AoD).

In another example, the WTRU may receive a request from the network to report measurements along with QCL information. The WTRU may receive association of measurement type with QCL information. For example, the WTRU may be configured to report timing and/or power measurements for type A QCL information. The WTRU may be configured to report AoA, phase, timing and/or power measurements for type D QCL information.

For example, multi-level secondary (backup) TCIs for improving robustness of TCI controls are provided. In a solution, the WTRU may receive an indication (e.g., by a DCI and/or MAC-CE) of multiple (e.g., multi-level) secondary (or backup) TCIs to be used for DL receptions and/or UL transmissions when (e.g., only when) the aforementioned at least one of conditions is met. Based on the indication, the WTRU may determine a first backup TCI and a second backup TCI. The WTRU may (be configured to) perform QCL tracking (e.g., based on at least one of typeA, typeB, typeC, and typeD) on the first backup TCI and/or the second backup TCI, in addition to the primary TCI (e.g., as a currently indicated TCI-state). The WTRU may determine the entry time T1 upon determining the aforementioned at least one of conditions is satisfied. The WTRU may further determine whether a quality metric (e.g., RSRP, L1-RSRP, CQI, SINR, L1-SINR, etc.) of the secondary TCI is above a second (configured) threshold.

On condition that the quality metric of the first backup TCI is above the second threshold, the WTRU may, at T1, start using the first backup TCI for DL receptions and/or UL transmissions (e.g., the particular group of DL receptions and/or UL transmissions), instead of using the primary TCI which has been used before T1.

On condition that the quality metric of the first backup TCI is below the second threshold (and/or a quality metric of the second backup TCI is above a third threshold), the WTRU may, at T1 or at T2 (being configured with an addition time-domain offset associated with the second backup TCI), start using the second backup TCI for DL receptions and/or UL transmissions (e.g., the particular group of DL receptions and/or UL transmissions), instead of using the primary TCI which has been used before T1 (or T2).

The WTRU may determine, e.g., as an exit condition (T3), to use again (e.g., fallback) the primary TCI after the third offset parameter (e.g., timer and/or time-window) has elapsed (e.g., at T3), since using the secondary TCI. This may provide benefits in terms of improving robustness of TCI determination based on more than one of secondary TCIs being used depending on the selection criteria.

For example, conditional fallback procedure when an exit condition is satisfied is provided. In a solution, the WTRU may (be configured to) determine whether performing the fallback to use the primary TCI after the exit condition (at T3) is satisfied. The WTRU may (be configured to) determine a quality metric (e.g., RSRP, L1-RSRP, CQI, SINR, L1-SINR, etc.) of the primary TCI is above a (configured) threshold before T3 (or at a reference time instance associated with the T3). On condition that the WTRU determines the quality metric of the primary TCI is above the (configured) threshold, the WTRU may perform fallback and start using (at T3) the primary TCI, instead of using the secondary TCI (up until T3). On condition that the WTRU determines the quality metric of the primary TCI is below the (configured) threshold, the WTRU may perform at least one of following: (1) Maintain using the secondary TCI (e.g., the first backup TCI or the second backup TCI), (2) Determine quality metrics of more than one of the backup TCIs (again) and select the best-quality backup TCI to use after T3, (3) Determine quality metrics of a set of candidate TCI-states (e.g., including the backup TCIs) and select the best-quality candidate TCI-state to use after T3, or (4) Initiate a beam failure recovery (BFR) procedure (e.g., at a time instance associated with T3 such as a (configured) time-offset earlier than T3 for early initiation of BFR), and follow a configured BFR procedure such as finding a candidate new beam RS and reporting to the NW (e.g., via a PRACH, a MAC-CE, a scheduling request (SR), or a PUCCH, etc.).

This may provide benefits in terms of improving robustness of beam quality of the primary TCI, based on determining the quality of the primary TCI after the exit condition is satisfied, and if the quality is below a threshold, the WTRU may determine a better-quality primary TCI to be used when the fallback occurs.

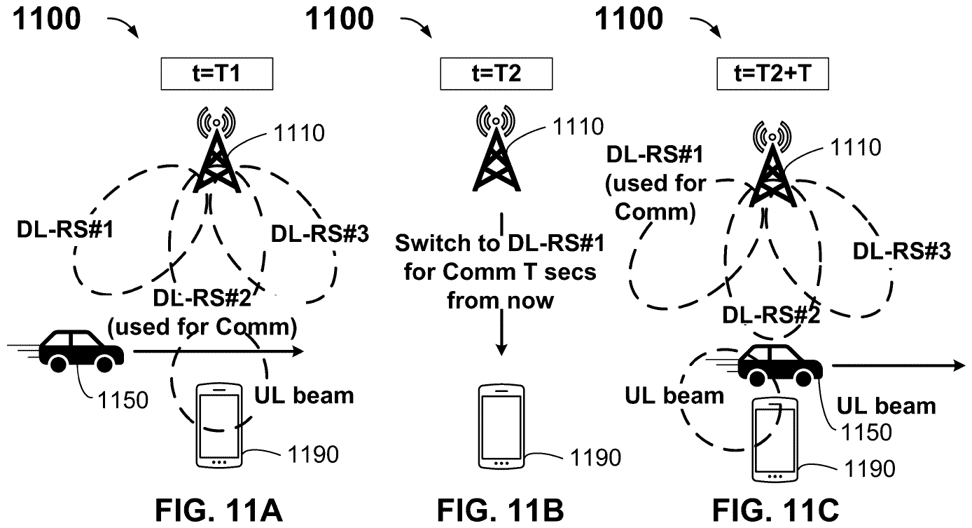

An example is illustrated in FIGS. 11A-11C. FIG. 11A is an example of a system 1100 including a beam between a gNB 1110 and a WTRU 1190 at a first time t=T1 before arrival of an obstacle or target 1150, in accordance with one or more embodiments of the present disclosure, FIG. 11B is an example of the system 1100 including a time scheduled beam switch at a second time t=T2 after the first time t=T1, in accordance with one or more embodiments of the present disclosure, and FIG. 11C is an example of the system 1100 including a switched beam between the gNB 1110 and the WTRU 1190 at a third time t=T2+T at arrival of the obstacle or target 1150, in accordance with one or more embodiments of the present disclosure.

In the example, WTRU 1190 is configured with the Rx beam that is spatially aligned to receive DL-RS #2. At t=T2, the WTRU 1190 may receive an indication from the network (e.g., gNB 1110) to change the Rx beam to receive DL-RS #1. The Rx beam may be aligned with UL transmission beam such that the WTRU 1190 transmits UL channels or signals along the direction of the Rx beam.

For example, for DL-RS, “Do not measure” and “Do not use” indicators are provided. Also, for example, primary behavior is measurement, and secondary behavior is to skip measurement. A WTRU may receive an indication to activate, deactivate or switch between from one DL-RS to another DL-RS (e.g., from a primary DL-RS to a secondary DL-RS) for measurement.

In one solution, the WTRU may receive an indication from the network of a primary DL-RS and/or a secondary DL-RS resource, where the primary and/or the secondary DL-RS may correspond to at least one of the following: (1) A primary and/or a secondary DL-RS resource ID or beam ID, (2) A primary and/or a secondary DL-RS resource set ID, (3) A primary and/or secondary DL-RS configuration (e.g., time, frequency resources, periodicity, etc.), (4) A primary and/or secondary sub-band, band, carrier, etc., (5) A primary and/or a secondary cell ID, or (6) A primary and/or a secondary TRP ID, etc.

The WTRU may receive an indication to activate, deactivate or switch between from one DL-RS to another (e.g., from a primary DL-RS to a secondary DL-RS). In one example, the indication may be a dynamic indication received by the WTRU (e.g., via DCI or MAC-CE). In one example, the indicated primary and/or secondary configuration may be a subset of a (pre) configured DL-RS.

In another example, the indication may be a semi-static configuration received by the WTRU (e.g., via RRC signaling).

An example of the DL-RS may be a CSI-RS or an SSB associated with one or more resource set ID(s), one or more configuration(s), one or more TRPs, etc. configured by the network for WTRU to make measurements and report.

The indication of primary and/or a secondary DL-RS may be an indication on which DL-RS to perform measurements and reporting or to not perform measurements and reporting on. In one example, the indication may be an indication for the WTRU to perform measurement and/or reporting on only one of primary or secondary DL-RS. In another solution, the indication may be an indication for the WTRU to not perform measurement and reporting on either a primary or a secondary DL-RS.

In another solution, the WTRU may be configured with a primary and a secondary DL-RS configuration (e.g., measurement configuration, reporting configuration, etc.) and the WTRU may determine to perform measurement and/or reporting of resource(s) associated with the primary DL-RS based on primary configuration and secondary DL-RS based on secondary configuration.

In another solution, the WTRU may be configured to activate, deactivate or switch the primary and/or secondary DL-RS based on at least one of the following conditions: (1) The WTRU receives an indication (e.g., via DCI) from the network, or (2) Based on at least one of the sensing measurements, for e.g., (a) At least one sensing measurement is above or below a (pre) configured threshold, (b) The difference between at least one sensing measurement (e.g., over measurement occasions, resource(s), resource set(s), etc.) is above or below a (pre) configured threshold, (c) At least one statistic associated with the sensing measurement is above or below a (pre) configured threshold, (d) The sensing target (e.g., EO) is located in an indicated area (e.g., zone ID), etc., or (e) The distance between the WTRU and a sensing target is above or below a (pre) configured threshold, etc.

In one solution, the WTRU may receive an indication (e.g., via DCI, MAC-CE, etc.) to (1) activate or deactivate a primary or secondary DL-RS, or (2) switch between primary or secondary DL-RS.

In another solution, the WTRU may receive a timing indication with the primary and/or the secondary DL-RS when to activate one or to switch from a one to another DL-RS. The WTRU may receive a timing indication as at least one of the following: (1) A primary and/or a secondary DL-RS measurement and/or reporting window, e.g., the WTRU may be configured with at a time window characterized by at least one of the following parameters: (a) Activation and/or deactivation of DL-RS indicator (e.g., activate, deactivate, etc.), (b) Switch DL-RS indicator, (c) Start time and/or end time (e.g., in terms of symbol and/or slot and/or frame and/or subframe index), (d) Duration (e.g., in terms of no. of symbols, slots, frames, subframes), (e) Timing offset (e.g., in terms of no. of symbols, slots, frames, subframes) with respect to a reference time, (f) Periodicity (e.g., in terms of no. of symbols, slots, frames, subframes), (2) A primary and/or secondary timer, e.g., the WTRU may start a timer when it receives an indication to activate one DL-RS. The WTRU may activate, deactivate or switch measurement and/or reporting associated with the DL-RS upon expiry of the associated timer, or (3) Time indication (e.g., in terms of symbol and/or slot and/or sub-frame and/or frame index), e.g., the WTRU may be configured with a sequence of timings, each associated with one or more DL-RSs in the primary or secondary DL-RS. The WTRU may be configured to activate, deactivate and/or switch the indicated UL-RS sequence in the indicated time sequence.

In one solution, the WTRU may report an indication of which DL-RS it used for measurement reporting (e.g., primary or secondary DL-RS, DL-RS ID, etc.).

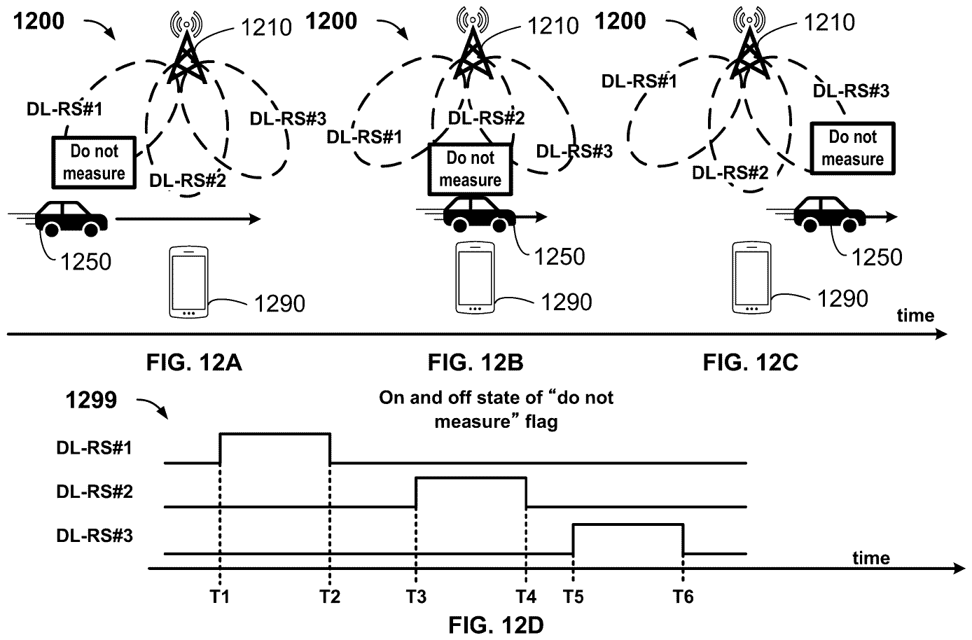

An example of “do not measure” indicator is shown in FIG. 12. In the example, the WTRU receives timing at which the WTRU shall not measure an associated DL-RS. In the example, the WTRU may receive a time window, active between t=T1 and t=T2, during which the WTRU determines not to measure DL-RS #1. During another window which is active between t=T3 and t=T4, the WTRU determines not to measure DL-RS #2. During another window which is active between t=T5 and t=T6, the WTRU determines not to measure DL-RS #3.

FIG. 12A is an example of a system 1200 including a “do not measure” flag for a first beam DL-RS #1 between a gNB 1210 and a WTRU 1290 at a first time period T1-T2 before arrival of an obstacle or target 1150, in accordance with one or more embodiments of the present disclosure, FIG. 12B is an example of the system 1200 including a “do not measure” flag for a second beam DL-RS #2 between the gNB 1210 and the WTRU 1290 at a second time period T3-T4 at arrival of the obstacle or target 1150, in accordance with one or more embodiments of the present disclosure, FIG. 12C is an example of the system 1200 including a “do not measure” flag for a third beam DL-RS #3 between the gNB 1210 and the WTRU 1290 at a third time period T5-T6 after departure of the obstacle or target 1150, in accordance with one or more embodiments of the present disclosure, and FIG. 12D is an example of a chart 1299 of the “do not measure” flags for the first, second, and third beams DL-RS #1, DL-RS #2, and DL-RS #3, at the first, second, and third time periods T1-T2, T3-T4, and T5-T6, in accordance with one or more embodiments of the present disclosure.

For example, for UL-RS, a “Do not transmit” indicator is provided. Also, for example, primary behavior is transmitting SRS, and secondary behavior is to skip transmission of SRS. In one example, the WTRU may be configured to transmit SRS. If the WTRU receives a notification that there can be a blockage between the WTRU and network, the WTRU may receive a request to terminate transmission of SRS temporarily. In another example, the WTRU may be configured to use the first SRS. The WTRU may determine to deactivate the first SRS and activate the second SRS based on a condition.

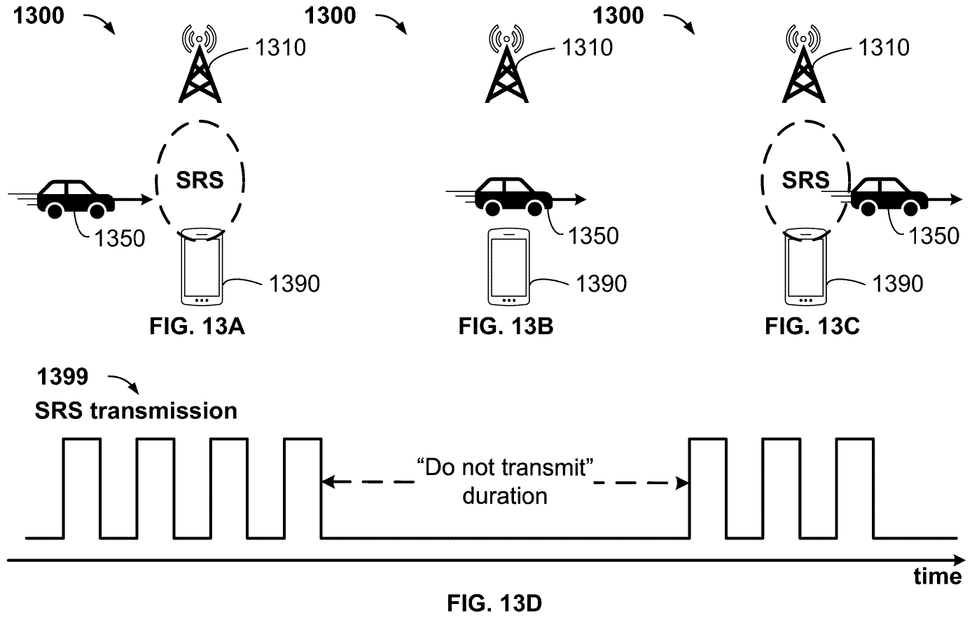

For example, a “Do not transmit” window is provided, during which the WTRU determines to cancel transmission of scheduled SRS or UL transmission (e.g., PUSCH), can be configured periodically, semi-persistently or in an aperiodic manner. An example of “Do not transmit” window is shown in FIG. 13. FIG. 13A is an example of a system 1300 including periodic transmit and/or receive of an SRS between a gNB 1310 and a WTRU 1390 at a first time period before arrival of an obstacle or target 1350, in accordance with one or more embodiments of the present disclosure, FIG. 13B is an example of the system 1300 including a “do not transmit” period for the SRS between the gNB 1310 and the WTRU 1390 at a second time period at arrival of the obstacle or target 1350, in accordance with one or more embodiments of the present disclosure, FIG. 13C is an example of the system 1300 including periodic transmit and/or receive of another SRS between the gNB 1310 and the WTRU 1390 at a third time period after departure of the obstacle or target 1350, in accordance with one or more embodiments of the present disclosure, and FIG. 13D is an example of a chart 1399 of the periodic transmit and/or receive of the SRSs before and after the “do not transmit” flag at the first, second, and third time periods, in accordance with one or more embodiments of the present disclosure.

The WTRU 1390 is configured with a window during which the WTRU 1390 does not transmit the configured SRS. Outside of the time window, the WTRU 1390 determines to transmit the configured SRS.

In one solution, the WTRU may be configured with a primary and/or secondary UL-RS, where the primary or secondary UL-RS may correspond to at least one of the following: (1) A primary and/or a secondary UL-RS resource ID or beam ID, (2) A primary and/or a secondary UL-RS resource set ID, (3) A primary and/or secondary UL-RS configuration (e.g., time, frequency resources, periodicity, etc.), (4) A primary and/or secondary sub-band, band, carrier, etc., (5) A primary and/or a secondary cell ID, or (6) A primary and/or a secondary TRP ID, etc.

The WTRU may receive an indication to activate, deactivate or switch between from one UL-RS to another (e.g., from a primary UL-RS to a secondary UL-RS). In one example, the indication may be a dynamic indication received by the WTRU (e.g., via DCI or MAC-CE). In one example, the indicated primary and/or secondary configuration may be a subset of a (pre) configured UL-RS. In another solution, the WTRU may receive the indication semi-statically (e.g., via RRC).

In one example, the WTRU may determine to transmit the first or second UL-RS before or after the configured window.

In one solution, the indication of primary and/or secondary UL-RS from the network may indicate the WTRU whether to transmit a UL-RS or not or the configuration to transmit the UL-RS.

In another solution, the WTRU may receive the primary and secondary UL-RS configurations, associated with primary UL-RS and secondary UL-RS.

In one solution, the WTRU may receive an indication (e.g., via DCI, MAC-CE, etc.) to (1) activate or deactivate a primary or secondary UL-RS, or (2) switch between primary or secondary UL-RS.

The WTRU may be configured to activate, deactivate or switch the primary and/or secondary UL-RS based on at least one of the following conditions: (1) The WTRU receives an indication (e.g., via DCI) from the network, or (2) Based on at least one of the sensing measurements, for e.g., (a) At least one sensing measurement is above or below a (pre) configured threshold, (b) The difference between at least one sensing measurement (e.g., over measurement occasions, resource(s), resource set(s), etc.) is above or below a (pre) configured threshold, (c) At least one statistic associated with the sensing measurement is above or below a (pre) configured threshold, (d) The sensing target (e.g., EO) is located in an indicated area (e.g., zone ID), etc., or (e) The distance between the WTRU and a sensing target is above or below a (pre) configured threshold, etc.

In another solution, the WTRU may receive a timing indication with the primary and/or the secondary UL-RS when to activate, deactivate one UL-RS to switch from a one to another UL-RS. The WTRU may receive a timing indication as at least one of the following: (1) A primary and/or a secondary UL-RS transmission window: e.g., The WTRU may be configured with at least a time window characterized by at least one of the following parameters: (a) Activation and/or deactivation of UL-RS indicator (e.g., activate, deactivate, etc.), (b) Switch UL-RS indicator, (c) Start time and/or end time (e.g., in terms of symbol and/or slot and/or frame and/or subframe index), (d) Duration (e.g., in terms of no. of symbols, slots, frames, subframes), (e) Timing offset (e.g., in terms of no. of symbols, slots, frames, subframes) with respect to a reference time, or (f) Periodicity (e.g., in terms of no. of symbols, slots, frames, subframes), (2) A primary and/or secondary timer, e.g., the WTRU may start a timer when it receives an indication to activate one UL-RS. The WTRU may switch or terminate the active UL-RS transmission upon expiry of the associated timer. Or, (3) Time indication (e.g., in terms of symbol and/or slot and/or sub-frame and/or frame index), e.g., the WTRU may be configured with a sequence of timings, each associated with one or more UL-RSs in the primary or secondary UL-RS. The WTRU may be configured to activate, deactivate and/or switch the indicated UL-RS sequence in the indicated time sequence.

For example, primary behavior is to measure and report, secondary behavior is to measure, report and transmit SRS (to accomplish RTT). In one example, The WTRU is originally configured to measure DL-RS for CSI reporting. During the configured duration, the WTRU makes measurements for sensing on the DL-RS and transmit SRS. After the configuration, the WTRU goes back to the default behavior, measure DL-RS for CSI reporting. The secondary behavior is to perform RTT for sensing purpose.

In one example, the WTRU may be configured to make measurements or transmit UL channels or signals. The WTRU may determine to perform RTT operation based on a condition. Examples of conditions may be the following: (1) Configured time window(s) during which the WTRU is expected to perform RTT operation, (2) The WTRU receives a request from the network to perform RTT operation, or (3) Measurement condition (e.g., RSRP of DL-RS below the threshold).

An example of RTT operation can be as follows. The WTRU may be configured to receive DL-RS. The WTRU may also be configured to transmit SRS. The WTRU may receive a request to report WTRU Rx-Tx time difference measurement which is the difference in time (e.g., frame number, absolute time) when the WTRU receives the configured DL-RS and time (e.g., frame number, absolute time) when the WTRU transmits SRS. The reception time or transmission time may be expressed in terms of the closest system time (e.g., slot number or index, SFN, frame number or index, symbol number or index). The WTRU may report power and/or phase measurement of the received DL-RS.

For example, switching frequency band during sensing or communication, primary is a data band, and secondary is sensing band. In one example, the WTRU may determine frequency configuration to use inside or outside of the configured window. For example, the WTRU may receive a timing indication with the primary and/or the secondary frequency band when to activate, deactivate one frequency band or to switch from a one to another frequency band.

In one solution, the WTRU may be configured with a primary frequency band and a secondary frequency band, where the primary and/or the secondary frequency band may correspond to at least one of the following: (1) A primary and/or secondary time and/or frequency resource (e.g., resource element, resource group, etc.), (2) A primary and/or secondary positioning or sensing frequency layer (PFL), (3) A primary and/or secondary bandwidth part, (4) A primary and/or secondary carrier, (5) A primary and/or secondary frequency band, etc., or (6) A primary and/or secondary frequency hopping pattern where hops in each pattern may cover non-overlapping frequency bands or resources.

In the examples herein, “band”, “frequency resources”, “bandwidth part”, “carrier”, “frequency band” or “frequency hopping pattern” may be used interchangeably.

In one example, at least one of the primary and/or secondary frequency band may correspond to frequency resources dedicated for communication purposes. In another example, at least one of the primary and/or secondary frequency band may correspond to frequency resources dedicated to sensing purposes. An example may be WTRU may be configured with a primary frequency band dedicated for communication purposes and a secondary frequency band dedicated for sensing purposes.

In one solution, the WTRU may receive an indication from the network to activate, deactivate or switch from one band to another (e.g., from a primary frequency band to a secondary frequency band). The WTRU may receive the indication dynamically (e.g., via DCI or MAC-CE) or semi-statically (e.g., via RRC signaling).

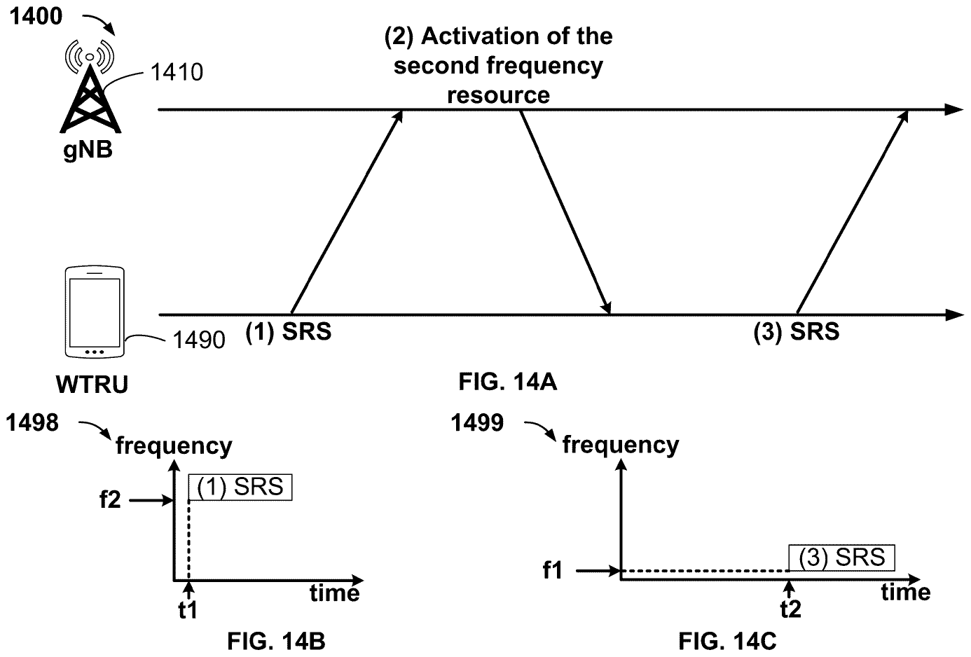

In another solution, the WTRU may be configured to activate, deactivate or switch the primary and/or secondary frequency band on at least one of the following conditions: (1) The WTRU receives an indication (e.g., via DCI) from the network. In one example, the indication may indicate activation or deactivation of first and/or second frequency band. An example is illustrated in FIGS. 14A-14C where the WTRU is configured with two non-overlapping frequency resources, one starting with frequency f2 and another starting with frequency f1. At t=t1, the WTRU is configured to transmit SRS using the first frequency resource starting at f=f2. The WTRU receives an activation command from the network, activating the second frequency resource starting at f=f1. The WTRU may receive, from the network, a deactivation command for the first frequency resource. The WTRU determine to transmit SRS using the second frequency resource. (2) The WTRU may receive an indication to switch a mode (e.g., sensing, communication) where each mode may be associated with time and/or frequency resources. Once the WTRU receives a command activating one of the modes, the WTRU may determine to use the time and/or frequency resources associated with the activated mode. Or, (3) Based on at least one of the sensing measurements, for e.g., (a) At least one sensing measurement is above or below a (pre) configured threshold. For example, the WTRU may be configured with a DL-RS and the WTRU may determine whether to switch to first or second frequency resource based on the measurement (e.g., RSRP) of the DL-RS. (b) The difference between at least one sensing measurement (e.g., over measurement occasions, resource(s), resource set(s), etc.) is above or below a (pre) configured threshold. (c) At least one statistic associated with the sensing measurement is above or below a (pre) configured threshold, (d) The sensing target (e.g., EO) is located in an indicated area (e.g., zone ID), etc. or (e) The distance between the WTRU and a sensing target is above or below a (pre) configured threshold, etc.

Based on at least one of the downlink measurements (e.g., CSI measurements), for e.g., (1) At least one measurement (e.g., L1-RSRP) is above or below a (pre) configured threshold, (2) The difference between at least one measurement (e.g., over measurement occasions, resources, resource sets etc.) is above or below a (pre) configured threshold, or (3) At least one CSI report quantity changes (e.g., PMI, CQI, RI, etc.), etc.

FIG. 14A is an example of a sequence diagram 1400 of activation of a frequency resource between a gNB 1410 and a WTRU 1490, in accordance with one or more embodiments of the present disclosure, FIG. 14B is an example of a chart 1498 of a first frequency resource f2 (e.g., SRS) at a first time t1, in accordance with one or more embodiments of the present disclosure, and FIG. 14C is an example of a chart 1499 of a second frequency resource f1 (e.g., SRS) at a second time, in accordance with one or more embodiments of the present disclosure.

In another solution, the WTRU may receive a timing indication with the primary and/or the secondary frequency band when to activate, deactivate one frequency band or to switch from a one to another frequency band. In the examples herein, activation of frequency band or resources imply that the WTRU may use the band or resources for DL measurements and/or transmission of UL-RS or channels. The WTRU may receive a timing indication as at least one of the following: (1) A primary and/or a secondary frequency band transmission and/or measurement and/or reporting window: (a) The WTRU may be configured with at least a time window characterized by at least one of the following parameters: (i) Activation and/or deactivation of frequency band indicator (e.g., activate, deactivate, etc.), (ii) Switch frequency band indicator, (iii) Start time and/or end time (e.g., in terms of symbol and/or slot and/or frame and/or subframe index), (iv) Duration (e.g., in terms of no. of symbols, slots, frames, subframes), (v) Timing offset (e.g., in terms of no. of symbols, slots, frames, subframes) with respect to a reference time, or (vi) Periodicity (e.g., in terms of no. of symbols, slots, frames, subframes), or (b) In one example, the WTRU may determine to make measurements or transmit UL-RS or UL channels using the first frequency resource inside the time window. The WTRU may determine to make measurements or transmit UL-RS or UL channels using the second frequency resource outside of the window. (2) A primary and/or secondary timer, e.g., The WTRU may start a timer when it receives an indication to activate one frequency band. The WTRU may switch or terminate the active frequency band upon expiry of the associated timer. Or, (3) Time sequence indication (e.g., in terms of symbol and/or slot and/or sub-frame and/or frame index), e.g., (a) The WTRU may be configured with a sequence of timings, each associated with one or more frequency bands in the primary or secondary frequency band. The WTRU may be configured to activate, deactivate and/or switch the indicated frequency band sequence in the indicated time sequence. Or, (b) An example of time sequence indication may be a solution similar to frequency hopping, where the WTRU may be configured to periodically switch from one frequency band to another.

In one solution, the WTRU may be configured to request the network (e.g., via UCI, MAC-CE, etc.) for activation, deactivation or switching from one frequency band to another frequency band.

For example, primary measurement and secondary measurement are provided. The WTRU is configured to make CSI measurements and report CSI. For DL-RS reception, measure RSRP before the trigger (start of the window). During the window the WTRU measures multipath measurements. After the window, the WTRU goes back to measuring RSRP.

In one example, the WTRU may be configured with a time window. The WTRU may be configured with first and second measurement. The WTRU may determine to make the first and second measurement on the same DL-RS or separate DL-RSs. The WTRU may determine to report first measurement outside of the time window and second measurement inside the time window.

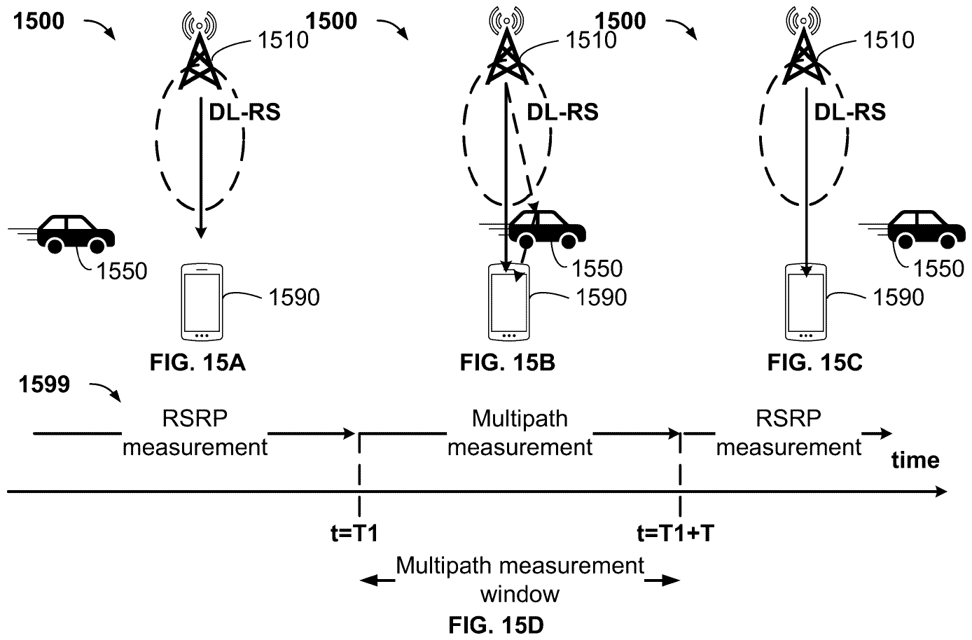

FIGS. 15A-15D show an illustrative example of a WTRU being configured to make measurements on the DL-RS. FIG. 15A is an example of a system 1500 including transmit and/or receive of a DL-RS for RSRP measurement between a gNB 1510 and a WTRU 1590 at a first time period t=x to t=T1 before arrival of an obstacle or target 1550, in accordance with one or more embodiments of the present disclosure. FIG. 15B is an example of the system 1500 including a multipath measurement for the DL-RS for the RSRP measurement between the gNB 1510 and the WTRU 1590 at a second time period t=T1 to t=T1+T at arrival of the obstacle or target 1550, in accordance with one or more embodiments of the present disclosure. FIG. 15C is an example of the system 1500 including transmit and/or receive of another DL-RS for another RSRP measurement between the gNB 1510 and the WTRU 1590 at a third time period t=T1+T to t=y after departure of the obstacle or target 1550, in accordance with one or more embodiments of the present disclosure. FIG. 15D is an example of a chart 1599 of the transmitted and/or received DL-RS and the multipath measurement for the RSRP measurement at the first, second, and third time periods (t=x . . . T1 . . . T1+T . . . y), in accordance with one or more embodiments of the present disclosure.

The WTRU 1590 may be configured with a time window that starts at t=T1 and ends at t=T1+T. The WTRU 1590 may be configured to make power measurements (e.g., RSRP) on the DL-RS before t=T1 and after t=T1+T. During the time window (e.g., between t=T1 and t=T1+T), the WTRU 1590 may determine to make timing measurements (e.g., PDP based on sample-based measurements). In another example, the WTRU 1590 may determine to make both first and second measurement (e.g., power and timing measuring) during the time window. The WTRU 1590 may report the measurement to the network. The WTRU 1590 may indicate association between the first and second measurement. The WTRU 1590 may indicate association between the measurement and DL-RS based on which the WTRU 1590 made measurements.

First and/or second measurement may include at least one of the following: (1) Power measurements, (2) Timing measurements, or (3) Phase measurements.

For example, entry and exit conditions are provided. For example, conditions are considered when a WTRU switches from the primary configuration to the secondary configuration, and when the WTRU switches back from the secondary configuration to the primary configuration. For example, time based switching between primary and secondary configuration is provided. In one example, the WTRU may determine to switch from the first configuration to the second configuration based on the configured time or timing.

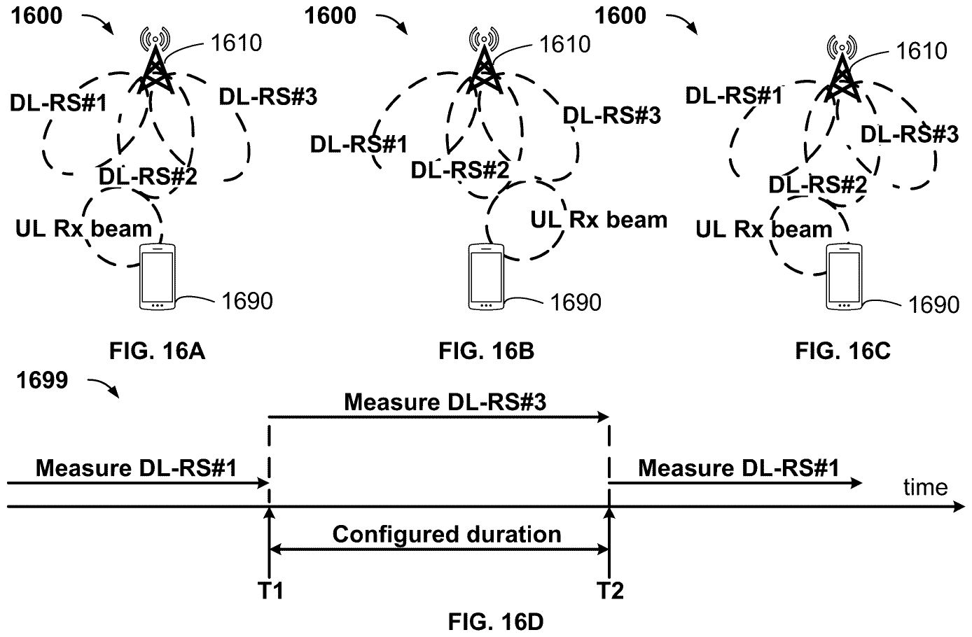

In one example, the WTRU may determine to switch from the first configuration to the second configuration based on the configured time or timing. As illustrated in FIG. 16, the WTRU may be configured with scheduled timing for T1 and T2. T1 and T2 may be expressed in terms of absolute time or relative time with respect to a reference time. The WTRU may be configured with a first configuration. The WTRU may also be configured with a second configuration. The WTRU may determine to deactivate the first configuration and activate the second configuration at T1. The WTRU may determine to deactivate the second configuration at T2. The WTRU may determine to activate the first configuration at T2 In the example illustrated in FIGS. 16A-16D, the first configuration may be spatial direction for UL Rx beam aimed toward DL-RS #1. The second configuration may be spatial direction of UL Rx beam aimed toward DL-RS #3.

FIG. 16A is an example of a system 1600 including transmit and/or receive of a first DL-RS between a gNB 1610 and a WTRU 1690 for a first measurement at a first time period t=x to T1, in accordance with one or more embodiments of the present disclosure, FIG. 16B is an example of the system 1600 including transmit and/or receive of a second DL-RS between the gNB 1610 and the WTRU 1690 for a second measurement at a second time period t=T1 to T2, in accordance with one or more embodiments of the present disclosure, FIG. 16C is an example of the system 1600 including transmit and/or receive of another first DL-RS between the gNB 1610 and the WTRU 1690 for a third measurement at a third time period t=T2 to y, in accordance with one or more embodiments of the present disclosure, and FIG. 16D is an example of a chart 1699 of the transmitted and/or received DL-RS and the measurements at the first, second, and third time periods t=x . . . T1 . . . T2 . . . y, in accordance with one or more embodiments of the present disclosure.

In one example, the WTRU 1690 determines reporting content as a function of time and identification of DL-RS. For example, during configured time window, the WTRU 1690 may determine to make measurements from the second DL-RS. The WTRU 1690 may determine to make measurements on the first DL-RS outside of the configured window. An exemplary embodiment is shown below.

A process includes at least one of: (1) The WTRU is configured with first and second DL-RS, and a duration (e.g., seconds), (2) The WTRU receives an activation command of the window via DCI (e.g., activation of a timer at the WTRU), e.g., DCI may indicate an index for the duration if the WTRU is configured with more than one durations where each duration is associated with an index, (3) The WTRU makes the first type of measurement (e.g., CQI) for the first DL-RS, e.g., The WTRU uses the TCI state corresponding to the first DL-RS for UL transmission, (4) If the first type of measurement satisfies a condition (e.g., CQI below a configured threshold), the WTRU determines to make measurements on the second DL-RS for the configured duration, (a) The WTRU reports both first and second type of measurement (e.g., power delay profile) for the second DL-RS to the network, or (b) The WTRU uses the TCI state corresponding to the second DL-RS for UL transmission, or (5) After the duration elapses, the WTRU makes the first type of measurement for the first DL-RS, e.g., The WTRU uses the TCI state corresponding to the first DL-RS for UL transmission.

For example, switching behavior based on data buffer status is provided. In one example, a WTRU may prioritize sensing operation and/or activity (over communication) based on the status of UL data activity. The WTRU determines to transmit SRS to a secondary TRP based on change in RSRP of the DL-RS transmitted from the first TRP and status of data buffer.

An exemplary embodiment is provided as follows. The exemplary embodiment includes at least one of: (1) The WTRU is configured with a DL-RS transmitted from the first TRP, (2) The WTRU receives notification from the network that the target is coming, (3) The WTRU receives DL-RS, or (4) The WTRU determines at least one of the following: (a) If RSRP of DL-RS associated with the first TRP is below the threshold, the WTRU determines to send an SR when UL data is pending in buffer and/or UL data is available and/or triggered from configured one of the UL logical channels, (b) If RSRP of DL-RS associated with the first TRP is below the threshold and there is no UL data pending and/or not available and/or no triggered UL data and/or no UL CG, the WTRU determines make measurements on the DL-RS transmitted from the first TRP, and reports power delay profile to the network, (c) If RSRP of DL-RS associated with the first TRP is above the threshold and there is no UL data pending and/or not available and/or no triggered UL data and/or no UL CG, the WTRU reports RSRP measurements made on DL-RS from the first TRP, or (d) If RSRP of DL-RS associated with the first TRP is above the threshold, the WTRU determines to send an SR when UL data is pending in buffer and/or UL data is available and/or triggered from configured one of the UL logical channels.

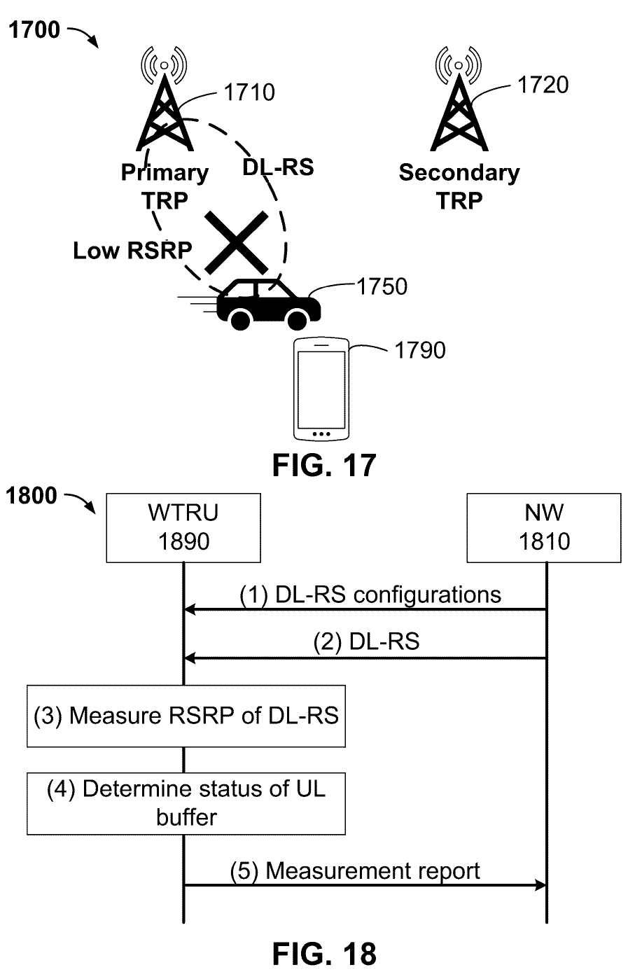

An example of low RSRP in received DL-RS due to the presence of the target (e.g., vehicle) is shown in FIG. 17. FIG. 17 is an example of a system 1700 including a low RSRP in a received DL-RS at a primary TRP 1710 due to a presence of a target 1750, in accordance with one or more embodiments of the present disclosure. The system 1700 also includes a secondary TRP 1720 and a WTRU 1790.

An example of signaling exchange between a WTRU and NW is shown in FIG. 18. FIG. 18 is an example of a sequence diagram 1800 of signal exchange between a WTRU 1810 and a network (NW) 1810, in accordance with one or more embodiments of the present disclosure. In the example, the WTRU 1890 receives (at step (1)) DL-RS configurations from the network. The WTRU 1890 receives (at step (2)) DL-RS from the network. The WTRU 1890 measures (at step (3)) RSRP of the received DL-RS. The WTRU 1890 determines (at step (4)) status of UL-buffer. Based on whether there is data in the UL-buffer, the WTRU 1890 determines to transmit (at step (5)) measurement report or SR. In the example, the content of the measurement report may depend on whether the measured RSRP is above or below the threshold.

In one example, a WTRU may prioritize sensing operation and/or activity (over communication) based on the status of UL data activity. The WTRU may receive configuration and associated conditions via RRC message and/or NAS message and/or indication and/or activation via DCI and/or MAC CE by a network. For example, upon receiving an indication (e.g., prioritization of sensing operation with conditions) from a network, the WTRU may determine to prioritize sensing operation based on UL data status.

The WTRU may determine to prioritize sensing measurements when there is no UL data activity and/or no configured with configured grant. Examples of no UL data activity or low activity for UL data are as follows. For example, there is no pending UL data in the WTRU buffer (i.e., the pending UL data may be scheduled via initial transmission and/or retransmissions and/or repetitions). For example, there is no triggered and/or available UL data associated with at least one of the configured UL logical channels. For example, the WTRU is not configured (e.g., no UL configured grant and/or UL-Small Data Transmission (SDT) while the WTRU is performing sensing measurement based on sensing window and/or duration. For example, upon receiving reconfiguration message with new configuration. For example, flushing the WTRU's buffer and/or WTRU's buffer is empty. For example, current pending data is below the configured threshold (e.g., less than xx bytes).

a) The WTRU may determine to prioritize sensing reporting when there is no UL data activity and/or no configured with configured grant. For example, the WTRU may determine to perform sensing measurement reporting via dedicated resource (e.g., dedicated SR, UCI, MAC CE, configured grant, PRACH preamble).

In one example, a WTRU may be configured with a first configuration of sensing operations for outside of active time (e.g., no DL data activity) from a network. The WTRU may be configured with the first configuration via RRC message and/or NAS message and/or DCI and/or MAC CE (e.g., indication and/or activation) by network.

For example, the WTRU may be configured with the first (or dedicated) sensing measurement and reporting configuration for outside of active time. The first sensing configuration may comprise one or more thresholds and/or sensing measurement duration and/or dedicated resource for sensing reporting.

Upon receiving an indication (e.g., activation of sensing operation outside active time), the WTRU may determine to use and/or activate the configured first sensing measurement and/or reporting configuration outside of active time. For example, the WTRU may determine to perform sensing measurements with the first threshold (e.g., DL-RSRP threshold for outside of active time). For example, the WTRU may perform sensing measurements with first sensing window and/or duration.

In one example, a WTRU may skip reporting sensing measurement results. For example, the WTRU may be a power saving WTRU and/or network may estimate and/or expect a periodic DL data with a long periodicity.

Upon receiving an indication (e.g., skipping the sensing measurement results outside of active time) from network, the WTRU may determine to skip report sensing measurement outside of active time. The WTRU may report and/or trigger sensing measurement results before starting the active time.

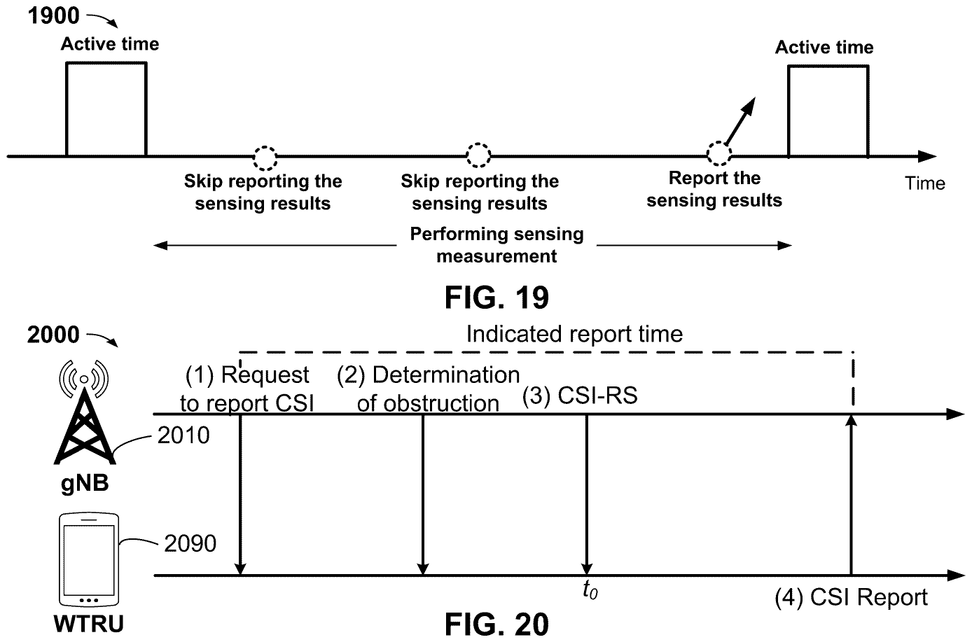

For example, as shown in FIG. 19 below, the WTRU may report the sensing measurement results with all skipped the sensing measurement results (i.e., outside of active time) before starting the active time (e.g., periodicity). FIG. 19 is an example of a chart 1900 of skipping reporting of sensing results outside of an active time (e.g., between first and second active time periods), in accordance with one or more embodiments of the present disclosure.

In one example, a WTRU may be configured with a second configuration of sensing operations for active time from a network. The WTRU may be configured with the second configuration via RRC message and/or NAS message and/or DCI and/or MAC CE (e.g., indication and/or activation) by network.

For example, the WTRU may be configured with the second (or dedicated) sensing measurement and reporting configuration using for active time. The second sensing configuration may comprise one or more thresholds and/or sensing measurement duration and/or dedicated resource sensing reporting.

Upon receiving an indication (e.g., activation of sensing operation during active time) from network, the WTRU may determine to use and/or activate the configured second sensing measurement and/or reporting configuration when running a timer (i.e., on duration timer, retransmission timer, inactivity timer) is running. For example, the WTRU may determine to perform sensing measurements with the second threshold (e.g., DL-RSRP threshold for active time). For example, the WTRU may determine to perform sensing measurements with second sensing window and/or duration (e.g., configured with set(s) of PDCCHs and/or DL-RSs and/or RBs). For example, the WTRU may determine to perform sensing measurement reporting via dedicated resource (e.g., dedicated SR, UCI, MAC CE, configured grant, PRACH preamble).

For example, a prioritization window is provided. In one example, the WTRU may be configured with a prioritization window. During the window, the WTRU may determine prioritization of sensing measurements and/or UL transmission for sensing purpose. The WTRU may be configured with a priority level (e.g., high, low, numerical indication of priority level such as 10 for high, 5 for medium, 1 for low priority) for sensing activity (e.g., making measurements for sensing, reporting sensing measurements, UL transmission for sensing) associated with the window. In another example, the WTRU may determine to prioritize sensing measurement and/or reporting during the window based on the status of UL data activity. For example, if there is no UL data, the WTRU may determine to transmit SRS in the configured or scheduled UL resources during the window.

In another example, the WTRU may determine to prioritize UL transmission (e.g., SRS) for sensing purpose over UL channel transmission (e.g., PUCCH) during the window.

The window may be activated or deactivated via MAC-CE by the network. The WTRU may send a request to the network to activate or deactivate the window.

For example, an activated consistency window before, during and/or after the entry and exit conditions is provided. In one example, the WTRU may be configured with a consistency window from the network, where the WTRU is indicated to keep WTRU-side conditions consistent.

In one example, the WTRU may be configured with a consistency window from the network, where the WTRU is indicated to keep its conditions consistent. The consistency window configuration parameters may consist of at least one of the following: (1) Start time and/or end time, for e.g., in terms of symbol index, slot index, frame index, subframe index, (2) Duration, for e.g., in terms of no. of symbols, slots, frames, sub-frame, etc., (3) Periodicity, for e.g., in terms of no. of symbols, slots, frames, sub-frame, etc., or (4) Offset, for e.g., in terms of no. of symbols, slots, frames, sub-frame, etc.

The WTRU may also be configured with the consistency parameters (e.g., WTRU side conditions), which it is expected keep consistent. The consistency parameter may include at least one of the following: (1) WTRU location, (2) WTRU velocity, (3) WTRU orientation, (4) WTRU hardware (e.g., antenna configuration), or (5) WTRU beam for transmission and/or reception etc.

In one solution, the WTRU may receive an indication of at least one of the consistency parameters in absolute terms. For example, the WTRU may receive an indication of WTRU location (e.g., in terms of location coordinates, or location area such as zone ID). In one example, the WTRU may determine that such absolute value indication may be one trigger condition for activating, deactivating or switching between the consistency windows. The WTRU may determine to activate the window if the WTRU determines satisfaction of at least one of the indicated absolute consistency window parameters. For example, the WTRU may be configured to activate the consistency window only when the WTRU is located in the indicated location indicated as consistency window parameter.

In another example, the WTRU may be configured with a relative consistency parameter indication. The WTRU may determine to activate, deactivate or switching between the consistency windows. For example, the WTRU may be configured with a relative value of velocity for the consistency window. The WTRU may be configured to activate, deactivate or switch the consistency window if the difference between at least one of the indicated parameters is above the indicated relative value. For example, the WTRU may be configured to activate, deactivate and/or switch the consistency window is the change in WTRU velocity is above the indicated relative velocity value.

In one example, the consistency window may be associated with a primary and/or a secondary configuration. The activation, deactivation or switching of consistency window may be an implicit indication for the WTRU to activate, deactivate and/or switch between configurations (e.g., between primary and secondary configurations).

In one solution, the WTRU may receive the consistency window dynamically from the network (e.g., via DCI, MAC-CE). In another solution, the WTRU may receive the consistency window configurations semi-statically (e.g., RRC). In one solution, the WTRU may receive one or more consistency windows semi-statically, but may receive indication of activation or deactivation dynamically.

As an example, the WTRU may receive the consistency window or an activation or deactivation indication of a consistency window along with the request for performing CSI measurements.

In one solution, the WTRU may receive the consistency window associated with at least one or both primary configuration (e.g., primary DL-RS. primary UL-RS, primary frequency band, primary measurement and/or reporting configurations, etc.) and/or a secondary configuration (e.g., secondary DL-RS. secondary UL-RS, secondary frequency band, secondary measurement and/or reporting configurations, etc.).

In one solution, the WTRU may activate, deactivate and/or switch from one configuration to another if at least one of the consistency conditions are not satisfied. For example, the WTRU may be configured to switch from a primary configuration to a secondary configuration if at least one of the consistency conditions are not satisfied.

In another solution, the WTRU may be configured to report the consistency parameter if at least one of the consistency conditions are not satisfied. For example, the WTRU may be configured to report the WTRU location if the location changes from one to another. The WTRU may report such conditions via an uplink channel (e.g., UCI, MAC-CE) independently or along with the next report (e.g., sensing measurement report, CSI report, etc.). In another example, the WTRU may report to the network when the consistency window is deactivated.

In one example, the WTRU may be configured to process measurements (e.g., average) during the window. The WTRU may determine to stop processing the measurements when the window is deactivated due to, for example, a change in WTRU side conditions during the window. The WTRU may indicate to the network that processing is interrupted.

In another example, the WTRU may determine to pause processing when the window is deactivated. The WTRU may be configured or determine to restart or continue processing once the time window is activated after the deactivation.

For example, event-based sensing is provided. The WTRU determines to trigger sensing activity when a condition is satisfied.

In one example, the WTRU may be configured with a time window during which the WTRU determines to perform sensing based on a configured condition(s). The WTRU may be configured with a start and/or end time (e.g., absolute time, relative time with respect to a reference time) at which the WTRU is configured to perform sensing based on a configured condition.

In another example, the WTRU may receive an indication or request from the network to perform sensing based on a configured condition.

The WTRU may perform sensing by performing at least one of the following: (1) Make measurements on DL-RS, (2) Transmit configured SRS, or (3) Sends a request to the network to activate or initiate sensing.

Examples of conditions may be at least one of following: (1) Measurement condition (e.g., RSRP of the DL-RS the WTRU is measuring is below the configured threshold), (2) Time event based (e.g., when the scheduled time is reached, the WTRU determines to perform sensing where the scheduled time may be indicated based on absolute time, relative time, SFN, slot index, for example), or (3) Event based (e.g., change in WTRU side condition (e.g., WTRU mobility, WTRU rotation), the WTRU receives a notification from the network that surrounding environment around the WTRU or NW side condition has changed)

For example, WTRU measurement reporting behavior is provided. In one example, the WTRU may determine the scheduled report content based on indication or determination of impending measurement degradation.

A gNB can trigger a WTRU to perform CSI measurements and send a CSI report on a specific indicated time, i.e., on an aperiodic basis by including a “CSI request” field in the Uplink DCI. To support the aperiodic CSI reporting process, first gNB configures a WTRU through RRC configuration, where the configuration may include at least one of the following: (1) CSI-RS Resource Configuration: The configuration defines at least one CSI-RS reference signal (CSI-RS) that the WTRU should use for channel measurements. The configured CSI-RS may take one of the following types, e.g., a Non-Zero Power (NZP) CSI-RS, Zero Power (ZP) CSI-RS or for interference measurement, etc., (2) CSI-Report Configuration: The configuration is used to determine the CSI-RS resource for measurement and the CSI quantities to be measured and reported. The measure and reported quantity may be one or more of CQI, PMI, RI, CRI, L1-RSRP, etc., as well as the reporting format, e.g., wideband or subband, etc., or (3) CSI-AperiodicTriggerStateList: This configuration provides one or more CSI-Report Configurations that are associated with the indicated value in the “CSI request” field of a received DCI. Each trigger state in this list corresponds to a set of CSI reports that the WTRU should perform when that trigger is received.

Once WTRU completes CSI measurements according to the received DCI and the configured CSI parameters, it reports the estimated CSI on the Physical Uplink Shared Channel (PUSCH) resource indicated by the triggering DCI.

Each of the values in the “CSI request” field corresponds to a specific trigger state configured in the CSI-AperiodicTriggerStateList RRC IE. Each trigger state, in turn, is associated with one or more CSI-ReportConfig instances, allowing the gNB to request multiple CSI reports with a single trigger.

FIG. 20 is an example of a sequence diagram 2000 of aperiodic channel state information (CSI) reporting in case of a disruption of reception of a CSI-RS between a gNB 2010 and a WTRU 2090, in accordance with one or more embodiments of the present disclosure. As shown in FIG. 20, in a solution, the WTRU 2090 may receive a dynamic indication, e.g., a DCI, for an aperiodic CSI report on a CSI-RS resource available no earlier than time to. As such, the WTRU 2090 may perform the requested measurement on the indicated CSI-RS resource, and report the CSI per indicated uplink reporting resource, e.g., PUSCH.

In one scenario, a WTRU receives a trigger for an aperiodic CSI, however, prior to time t0, the WTRU may determine that reception of the indicated CSI-RS for measurement may not be reliable,

In one example, a WTRU may receive an early indication from an external entity, e.g., a TRP, a peer WTRU, gNB, etc., as an early warning that the transmission of the indicated CSI-RS for measurement may be impacted by a blockage, a change in channel delay profile, measurement of more than one paths, spread in delay profile, introduction or disappearance of paths in the measurement, etc.

In another example, a WTRU may predict an impending disruption on the reception of the configured CSI-RS measurement by detecting other events or other changes in the channel, e.g., change in the channel delay profile, change in the pathloss, etc.

In one example, the indication from the network (e.g., gNB) may include at least one of the following: (1) Timing or range of time at or during which degradation may occur. Timing or range of time may be expressed in terms of absolute time (e.g., seconds), relative time with respect to a reference time (e.g., timing at which the WTRU is expected to report the measurement), system time (e.g., slot index, frame index, subframe index, SFN). In one example the WTRU may receive an indication or configuration of a time windows during which the WTRU may experience degradation in DL measurements, (2) Configuration associated with the measurement which may be impacted (e.g., CSI-RS resource index), (3) Configuration for a second DL-RS which the WTRU shall measure if a condition(s) is satisfied (e.g., RSRP of the first DL-RS is below the configured threshold where the WTRU is configured to measure the first DL-RS), or (4) Measurement the WTRU shall report if a condition(s) is satisfied (e.g., the WTRU shall report DP if RSRP of the DL-RS is below the configured threshold). The WTRU may receive the indication (e.g., indication of degradation of measurements, indication of incoming target) from a NW entity such as LMF, sensing function, gNB, or core network entity.

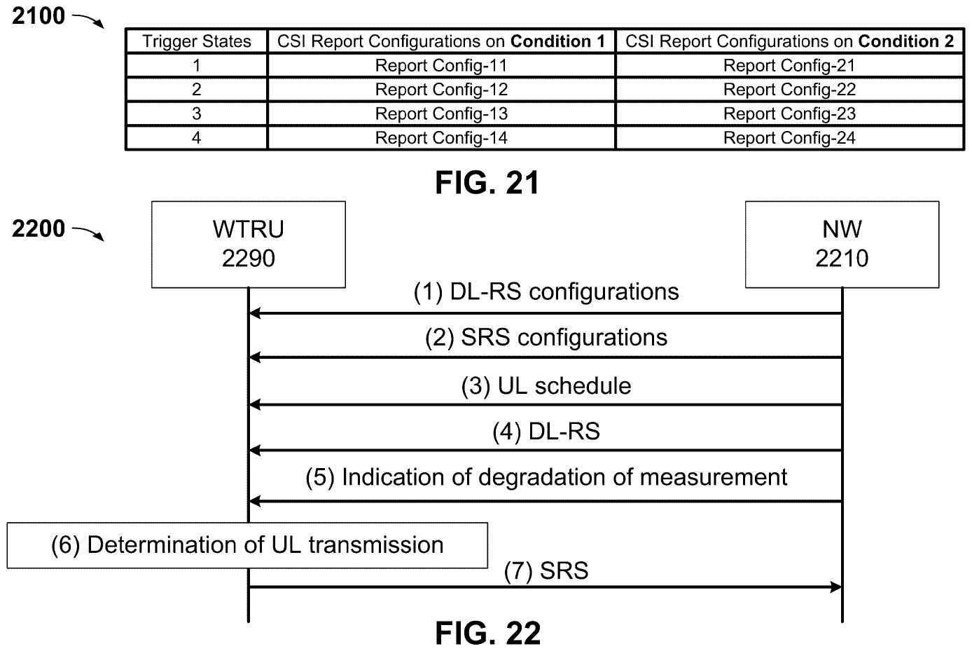

In a solution, when a WTRU determines an impending degradation in the reception of the indicated CSI-RS for measurement, it may proceed with one or more of the following: (1) In one solution, despite the perceived degradation, a WTRU may perform and report CSI measurement according to the configuration indicated by the CSI request field in the DCI, (a) If L1-RSRP is not among the requested measurements in the configured report quantity, the WTRU may also include an L1-RSRP in its report as an indication of the reliability of the report. If the inclusion of the L1-RSRP in the report increases the size of the CSI payload to beyond the PUSCH size indicated by the triggering DCI, the WTRU may prioritize reporting of L1-RSRP by dropping other CSI quantities, e.g., PMI, CQI, etc., or (b) Alternatively, the WTRU may simply use a single bit flag as an indicator of potentially low reliability of the reported CSI. In another solution, a WTRU may use a specific combination of configured CSI quantity values as an indication of potentially low reliability of the reported CSI, (2) In an alternative solution, when a WTRU determines an impending degradation in the reception of the indicated CSI-RS for measurement, the WTRU may not perform and report CSI measurement according to the configuration indicated by the CSI request field in the DCI. Instead, it may replace the configured report quantity with another measurement which may assist gNB with an updated TRP association for the WTRU. For example, the replacement measurement may be one or more of rank, channel delay profile measurement, L1-RSRP of the configured CSI-RS, a new beam report based on other configured reference signals, e.g., other CSI-RSs, SSBs, etc., FIG. 21 is an example of CSI report configurations 2100 for first and second conditions and for four triggers states, in accordance with one or more embodiments of the present disclosure, (3) In another exemplary solution, as demonstrated in FIG. 21, the CSI trigger state is defined conditionally. Hence, as a general solution, conditioned on a determined, indicated or configured state, event, measurement, mode, etc., for a given indicated trigger state, a WTRU may use one set of CSI configuration report versus another. For example, depending on whether the WTRU has determined an obstruction on reception of the configured CSI-RS, a WTRU may perform CSI measurement according to a first or a second Report Configuration measurement corresponding to the indicated trigger state. (a) In one implementation, each codepoint in the CSI Request field in the DCI may correspond to two groups of CSI-RS configurations and CSI report, where in each group, there may be more than one set of configurations, e.g., For example, if WTRU does not determine an incoming degradation on the configured CSI-RS, WTRU may proceed to perform and report CSI measurement according to the first configuration group indicated by the CSI request field in the DCI. And when it determines an incoming degradation on the configured CSI-RS, WTRU may perform and report CSI measurement according to the second configuration group indicated by the CSI request field in the DCI. Or, (b) In another example, each trigger state may be associated with two types of measurements where each type is associated with a condition. For example, if condition 1 is satisfied, the WTRU may report RSRP for CSI-RS. If condition 2 is satisfied, the WTRU may report sampled-based measurements (e.g., multipath measurement) based on a configured DL-RS. Condition 1 may be the default configuration. The WTRU may report the measurement associated with condition 2 in addition to the measurement associated with condition 1. The WTRU may receive, from the network, the trigger state via dynamic (e.g., DCI, MAC-CE) or semi-static message (e.g., LPP, NAS, RRC). Examples of association of measurements are explained herein (e.g., see, herein, association of sensing measurements and communication measurements). Or, (4) In another exemplary solution, a WTRU may also be configured with an SRS resource. When the WTRU determines an impending degradation in the reception of the indicated CSI-RS for measurement, it may transmit an SRS using the configured SRS resource. (a) If the blockage is indicated by the gNB, then gNB may expect an SRS transmission using the configured SRS resource. Or (b) However, if the blockage or the anticipated disruption was determined by the WTRU or another external entity, (i) If the configured SRS resource is before the PUSCH resource for CSI reporting, WTRU transmit SRS, and it may not report any CSI by the indicated PUSCH resource in the triggering DCI. Or, (ii) When the configured SRS resource is after the PUSCH resource for CSI reporting, a WTRU may indicate transmission of the pending SRS in the PUSCH.

In another example, when the WTRU determines an impending degradation in the reception of the indicated CSI-RS for measurement, the WTRU may determine to transmit SRS in the next available UL resource. The WTRU may determine to transmit a preconfigured SRS in the UL resource. The WTRU may receive more than one pre-configurations of SRS where each pre-configuration may be associated with a cause (e.g., degradation of RSRP for CSI-RS, presence of multipath).

In another example, if the time window is configured and the WTRU expects degradation of quality of measurements during the time window, and the WTRU is configured with UL resources during the time window, the WTRU may determine to prioritize SRS transmission over transmission of UL channels during the time window. In another example, the WTRU may determine to make measurements on the configured DL-RS (e.g., CSI-RS) inside and/or outside of the time window. The WTRU may receive periodic, semi-persistent, or aperiodic DL-RS for measurement. The WTRU may receive periodic DL-RS for measurements during the time window. In another example, the WTRU may report the measurements outside or inside of the time window. The WTRU may indicate to the network whether the measurements satisfy the condition. The WTRU may determine whether the measurement satisfies the condition (e.g., RSRP of the received DL-RS is below the threshold) within the time window or outside of the time window. The WTRU may be scheduled with the UL resources prior to configuration of the time window.

See, for example, FIG. 5 for the example of the sequence diagram 500 of communications aided by sensing results between the gNB 510 and the WTRU 590. In the example, the WTRU 590 receives schedule for UL transmission from the network (e.g., gNB 510) (e.g., UL transmission of PUSCH). In FIG. 5, the scheduled resource is indicated as “UL tx occasion”. After the WTRU 590 receives (at step (1)) the schedule, the WTRU 590 receives (at step (2)) an indication from the network that a target(s) are incoming, and it may degrade quality of DL measurements. The WTRU 590 may receive (at step (3)) an activation command of a time window in the indication. The activated time window may overlap with the scheduled UL resources. The WTRU 590 may determine to transmit (pre)-configured SRS in the UL resources that are located inside the window, instead of transmitting scheduled signals or channels (e.g., PUSCH). The received SRS by the network may be used to make measurements on the incoming target(s).

In one example, if the WTRU predicts degradation of measurement in the configured DL-RS, the WTRU may report the prediction result in the measurement report. For example, the prediction result may be at least one or combination of the following: (1) amount of degradation in the measurement (e.g., RSRP) the WTRU predicted (e.g., by 3 dB), (2) one bit indicating whether the measurement is predicted to degrade or not, (3) type of measurement (e.g., RSRP) which is expected to degrade, (4) timing or range of time during which the indicated measurement is expected to degrade where timing or range of time may be expressed in terms of absolute time or system time (e.g., symbol index, slot index, frame index, relative time with respect to a reference time, SFN, etc.), or (5) configuration associated with the measurement (e.g., index of the CSI-RS resource the WTRU is expected to measure).

In the examples described herein, conditions may refer to any one of the following: (1) Measurement (e.g., RSRP) is below or above the configured threshold, (2) Statistical characteristics (e.g., standard deviation of RSRP, delay spread of the measured channel) is below or above the configured threshold, (3) Number of paths measured by the WTRU is below or above the configured threshold, or (4) Change in measurement is above the threshold (e.g., change in RSRP compared to the last occasion of the measurement of RSRP is greater than the threshold, change in RSRP compared to the average RSRP is greater than the threshold where the average RSRP is determined based on a method such as a sliding window or configured number of measurements).

In one example, the WTRU may determine that the scheduled UL resource is not enough to transmit the configured SRS. For example, the WTRU may determine that the number of symbols and/or frequency resources are not enough to transmit the configured SRS. In such a case, the WTRU may determine to truncate the configured SRS so that it can be transmitted in the scheduled resource. For example, if the WTRU determines that the scheduled resource has 10 symbols, but the configured SRS requires 12 symbols, the WTRU may determine to transmit the first 10 symbols from the configured SRS.

Exchange of signaling between the WTRU and NW is shown in FIG. 22. FIG. 22 is an example of a sequence diagram 2200 of signals between a WTRU 2290 and a NW 2210, in accordance with one or more embodiments of the present disclosure. The WTRU 2290 receives (at steps (1) and (2)) DL-RS configurations and SRS configurations from the network. The WTRU 2290 receives (at step (3)) the UL schedule from the NW. It is not shown in FIG. 22, but the WTRU 2290 may send a scheduling request (SR) for the UL schedule. The WTRU 2290 receives (at step (4)) DL-RS form the network 2210. The WTRU 2290 receives (at step (5)) an indication of degradation of measurement from the network. The WTRU 2290 determines (at step (6)) the content of UL transmission, e.g., whether to send the scheduled UL channels or SRS for sensing purpose. The WTRU 2290 determines to send (at step (7)) the SRS for sensing purpose in the example.

By implementing WTRU behavior based on a presence of a target, disruption of communication can be minimized, and a network can obtain results (e.g., sensing results) for further analysis of disruption of communication (e.g., to determine whether communication with the WTRU has been interrupted, whether the disruption will persist and for how long, and the like).

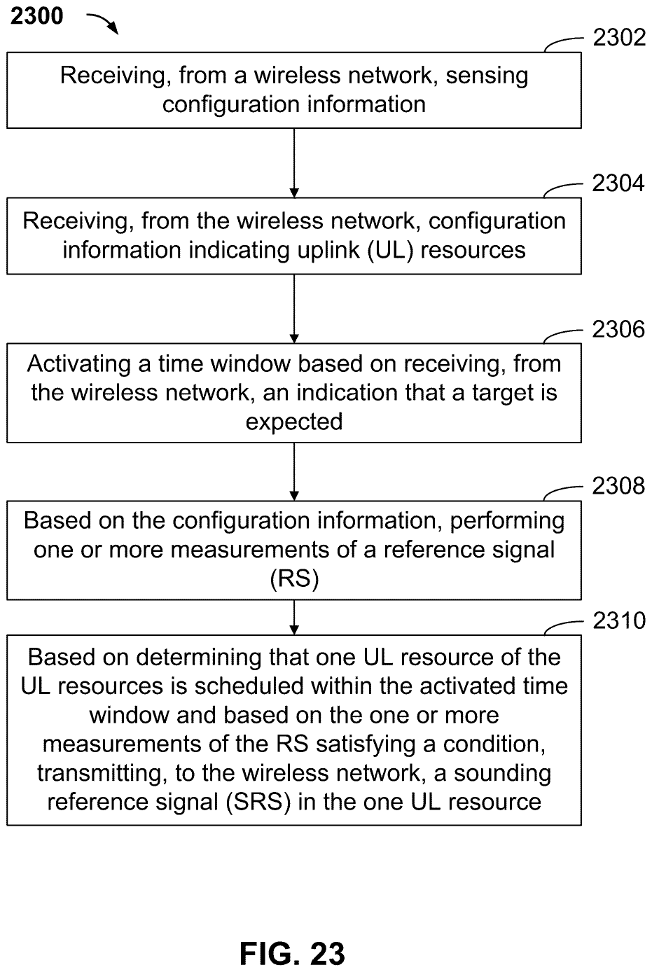

FIG. 23 is a flowchart of an example process 2300. FIG. 23 is an example process for communications aided by sensing-related measurements, in accordance with one or more embodiments of the present disclosure. In some implementations, one or more process blocks of FIG. 23 may be performed by a device (e.g., WTRU 102, 390, 490, 590, 704, 1190, 1290, 1390, 1490, 1590, 1690, 1790, 1890, 2090, 2290).

As shown in FIG. 23, process 2300 may include at least one of receiving 2302, from a wireless network (e.g., RAN 104, gNB 180a, 180b, 180c, RAN 113, gNB 310, gNB 320, gNB 410, gNB 510, TRP 702, gNB 1110, gNB 1210, gNB 1310, gNB 1410, gNB 1510, gNB 1610, gNB 1710, NW 1810, gNB 2010, NW 2210), sensing configuration information, receiving 2304, from the wireless network, configuration information indicating uplink (UL) resources (e.g., FIG. 5, step (1)), activating 2306 a time window (e.g., FIG. 5) based on an indication received from the wireless network that a target is expected (e.g., FIG. 5, step (2)), based on the configuration information, performing 2308 one or more measurements of a reference signal (RS), or based on determining that a UL resource of the UL resources is scheduled within the activated time window and based on the one or more measurements of the RS satisfying a condition (e.g., FIG. 6), transmitting 2310, to the wireless network, a sounding reference signal (SRS) in the UL resource (e.g., FIGS. 7-10, SRS #1 714, SRS #2 716, FIG. 13, FIGS. 14A-14C). For example, device (e.g., WTRU 102, 390, 490, 590, 704, 1190, 1290, 1390, 1490, 1590, 1690, 1790, 1890, 2090, 2290) may be configured to perform at least one of: receiving 2302, from a wireless network, sensing configuration information, receiving 2304, from the wireless network, configuration information indicating uplink (UL) resources, activating 2306 a time window based on an indication received from the wireless network that a target is expected, based on the configuration information, performing 2308 one or more measurements of a reference signal (RS), or based on determining that a UL resource of the UL resources is scheduled within the activated time window and based on the one or more measurements of the RS satisfying a condition, transmitting 2310, to the wireless network, a sounding reference signal (SRS) in the UL resource, as described above.

Process 2300 may include additional implementations, such as any single implementation or any combination of implementations described below and/or in connection with one or more other processes described elsewhere herein. A first implementation, process 2300 further includes based on the one or more measurements of the RS not satisfying the condition, transmitting, to the wireless network, a transmission in the UL resource where the transmission comprises at least one of a physical uplink shared channel (PUSCH) transmission or a physical uplink control channel (PUCCH) transmission.

In a second implementation, alone or in combination with the first implementation, the configuration information further indicates: a first indication of a first transmission configuration indicator (TCI)-state for downlink (DL) receptions and/or UL transmissions, and a second indication of a second TCI-state for the DL receptions and/or the UL transmissions.

In a third implementation, alone or in combination with the first and second implementation, the at least one of the PUSCH transmission or the PUCCH transmission is based on receipt of an explicit indication from the wireless network, or receipt of a time-domain offset parameter from the wireless network.

In a fourth implementation, alone or in combination with one or more of the first through third implementations, the first TCI-state for the DL receptions and/or the UL transmissions switches to the second TCI-state for the DL receptions and/or UL transmissions at a configured time.

In a fifth implementation, alone or in combination with one or more of the first through fourth implementations, the condition comprises a reference signal received power (RSRP) being below a configured threshold.

In a sixth implementation, alone or in combination with one or more of the first through fifth implementations, process 2300 further includes determining the one or more measurements of the RS satisfy the condition before the activated time window, and based on the sensing configuration information, performing one or more sensing measurements within the activated time window.

In a seventh implementation, alone or in combination with one or more of the first through sixth implementations, process 2300 further includes determining the one or more measurements of the RS satisfy the condition within the activated time window.

An eighth implementation, alone or in combination with one or more of the first through seventh implementations, process 2300 further includes based on determining that another UL resource of the UL resources is scheduled outside the activated time window, transmitting, to the wireless network, at least one of a physical uplink shared channel (PUSCH) transmission or a physical uplink control channel (PUCCH) transmission in the another UL resource.

A ninth implementation, alone or in combination with one or more of the first through eighth implementations, process 2300 further includes based on the sensing configuration information, performing one or more measurements of the RS after the activated time window and before another activated time window, and transmitting, to the wireless network, a report indicating the one or more measurements of the RS before activating the another activated time window.

Although FIG. 23 shows example blocks of process 2300, in some implementations, process 2300 may include additional blocks, fewer blocks, different blocks, or differently arranged blocks than those depicted in FIG. 23. Additionally, or alternatively, two or more of the blocks of process 2300 may be performed in parallel.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU), (ii) any of a number of embodiments of a WTRU, (iii) a wireless-capable and/or wired-capable (e.g., tetherable) device configured with, inter alia, some or all structures and functionality of a WTRU, (iv) a wireless-capable and/or wired-capable device configured with less than all structures and functionality of a WTRU, or (v) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, or methods described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing and/or communication and/or network computing and/or communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, § 6 or § 112 (f), or means-plus-function claim format, and any claim without the terms “means for” is not so intended.

What is claimed is:

1. A method performed by a wireless transmit and/or receive unit (WTRU), the method comprising:
receiving, from a wireless network, sensing configuration information,
receiving, from the wireless network, configuration information indicating uplink (UL) resources,
activating a time window based on an indication received from the wireless network indicating that a target is expected,
based on the configuration information, performing one or more measurements of a reference signal (RS), and
based on determining that a UL resource of the UL resources is scheduled within the activated time window and based on the one or more measurements of the RS satisfying a condition, transmitting, to the wireless network, a sounding reference signal (SRS) in the UL resource.

2. The method of claim 1, further comprising:
based on the one or more measurements of the RS not satisfying the condition, transmitting, to the wireless network, a transmission in the UL resource wherein the transmission comprises at least one of a physical uplink shared channel (PUSCH) transmission or a physical uplink control channel (PUCCH) transmission.

3. The method of claim 2, wherein the configuration information further indicates:
a first indication of a first transmission configuration indicator (TCI)-state for downlink (DL) receptions and/or UL transmissions, and
a second indication of a second TCI-state for the DL receptions and/or the UL transmissions.

4. The method of claim 3, wherein the at least one of the PUSCH transmission or the PUCCH transmission is based on receipt of an explicit indication from the wireless network, or receipt of a time-domain offset parameter from the wireless network.

5. The method of claim 3, further comprising:
switching the first TCI-state for the DL receptions and/or the UL transmissions to the second TCI-state for the DL receptions and/or UL transmissions at a configured time.

6. The method of claim 1, wherein the condition comprises a reference signal received power (RSRP) being below a configured threshold.

7. The method of claim 6, further comprising:
determining the one or more measurements of the RS satisfy the condition before the activated time window, and
based on the sensing configuration information, performing one or more sensing measurements within the activated time window.

8. The method of claim 6, further comprising determining the one or more measurements of the RS satisfy the condition within the activated time window.

9. The method of claim 1, further comprising:
based on determining that another UL resource of the UL resources is scheduled outside the activated time window, transmitting, to the wireless network, at least one of a physical uplink shared channel (PUSCH) transmission or a physical uplink control channel (PUCCH) transmission in the another UL resource.

10. The method of claim 1, further comprising:
based on the sensing configuration information, performing one or more measurements of the RS after the activated time window and before another activated time window, and
transmitting, to the wireless network, a report indicating the one or more measurements of the RS before activating the another activated time window.

11. A wireless transmit and/or receive unit (WTRU), comprising:
a processor, and
a transceiver coupled to the processor, wherein the WTRU is configured to:
receive, from a wireless network, sensing configuration information,
receive, from the wireless network, configuration information indicating uplink (UL) resources,
activate a time window based on an indication received from the wireless network indicating that a target is expected,
based on the configuration information, perform one or more measurements of a reference signal (RS), and
based on determining that a UL resource of the UL resources is scheduled within the activated time window and based on the one or more measurements of the RS satisfy a condition, transmitting, to the wireless network, a sounding reference signal (SRS) in the UL resource.

12. The WTRU of claim 11, wherein the processor is further configured to:
based on the one or more measurements of the RS not satisfying the condition, transmitting, to the wireless network, a transmission in the UL resource, wherein the transmission comprises at least one of a physical uplink shared channel (PUSCH) transmission or a physical uplink control channel (PUCCH) transmission.

13. The WTRU of claim 12, wherein the configuration information further indicates:
a first indication of a first transmission configuration indicator (TCI)-state for downlink (DL) receptions and/or UL transmissions, and
a second indication of a second TCI-state for the DL receptions and/or the UL transmissions.

14. The WTRU of claim 13, wherein the at least one of the PUSCH transmission or the PUCCH transmission is based on receipt of an explicit indication from the wireless network, or receipt of a time-domain offset parameter from the wireless network.

15. The WTRU of claim 13, wherein the processor is further configured to switch the first TCI-state for the DL receptions and/or the UL transmissions to the second TCI-state for the DL receptions and/or UL transmissions at a configured time.

16. The WTRU of claim 11, wherein the condition comprises a reference signal received power (RSRP) being below a configured threshold.

17. The WTRU of claim 16, wherein the processor is further configured to:
determine that the one or more measurements of the RS satisfy the condition before the activated time window, and
based on the sensing configuration information, perform one or more sensing measurements within the activated time window.

18. The WTRU of claim 16, wherein the processor is further configured to determine that the one or more measurements of the RS satisfy the condition within the activated time window.

19. The WTRU of claim 11, wherein the processor is further configured to:
based on determining that another UL resource of the UL resources is scheduled outside the activated time window, transmit, to the wireless network, at least one of a physical uplink shared channel (PUSCH) transmission or a physical uplink control channel (PUCCH) transmission in the another resource.

20. The WTRU of claim 11, wherein the processor is further configured to:
based on the sensing configuration information, perform one or more measurements of the RS after the activated time window and before another activated time window, and
transmit, to the wireless network, a report indicating the one or more measurements of the RS before activating the another activated time window.
